(19) United States
(12) Patent Application Publication
(10) Pub. No.: US 2014/0348220 A1
(43) Pub. Date: Nov. 27, 2014

(54) IMAGE PROCESSING APPARATUS AND IMAGE PROCESSING METHOD

(71) Applicant: Sony Corporation, Tokyo (JP)

(72) Inventor: Kazushi Sato, Kanagawa (JP)

(73) Assignee: SONY CORPORATION, Tokyo (JP)

(21) Appl. No.: 14/345,454

(22) PCT Filed: Oct. 18, 2012
(86) PCT No.: PCT/JP2012/076980

§ 371 Date: Mar. 18, 2014

(30) Foreign Application Priority Data
Dec. 14, 2011 (JP) 2011-273444

(51) Int. Cl. H04N 19/39; H04N 19/91; H04N 13/00; H04N 19/463

(52) U.S. Cl. CPC H04N 19/0046; H04N 19/00551; H04N 19/00951; H04N 13/0048
USPC 375/240.01

(57) ABSTRACT

There is provided an image processing apparatus including a code number table that holds a pair of a code number used in entropy coding and an index value of a syntax element, a first conversion section that converts a first code number associated with a codeword contained in an encoded stream of a first picture of two or more pictures corresponding to a common scene into a first index value by referring to the code number table, and a second conversion section that converts a second code number associated with a codeword contained in an encoded stream of a second picture of the two or more pictures into a second index value by referring to the code number table.

### TECHNICAL FIELD

The present disclosure relates to an image processing apparatus and an image processing method.

### BACKGROUND ART

As the next-generation image coding scheme subsequent to H.264/AVC, the standardization of HEVC (High Efficiency Video Coding) is under way. In HEVC, various constituent technologies are being improved from the aspect of AVC (Advanced Video Coding). In the contributed article JCTVC-A119, for example, a technique that is different from CABAC (Context-based Adaptive Binary Arithmetic Coding) and CAVLC (Context-based Adaptive VLC) of entropy coding of AVC is proposed as an entropy coding technique (see Non-Patent Literature 1 below).

When compared with CAVLC, CABAC needs complex operations for arithmetic coding while coding efficiency thereof is high. Thus, in the baseline profile of H.264/AVC, CABAC is not used and instead, CAVLC is used. In contrast, the entropy coding technique proposed in JCTVC-A119, though VLC (Variable Length Coding) like CAVLC, can deliver performance close to that of CABAC and so its use in devices of low operation capabilities including mobile devices like mobile phones is expected.

In the entropy coding technique proposed in JCTVC-A119, an encoder and a decoder store a code number table holding pairs of a code number associated with each codeword and an index value of a syntax element. Then, when some index value appears at the time of encoding or decoding, the index value that has appeared and the index value immediately above (that is, the index value whose code number is smaller by 1) are swapped in the code number table. With such swapping being repeated, an index value with a relatively high frequency is associated with a smaller code number. As a result, compression of the code amount, which is an advantage of entropy coding, is achieved.

Incidentally, scalable video coding (SVC) is one of important technologies for future image coding schemes. The scalable video coding is a technology that hierarchically encodes a layer transmitting a rough image signal and a layer transmitting a fine image signal. Typical attributes hierarchized in the scalable video coding mainly include the following three:
Space scalability: Spatial resolutions or image sizes are hierarchized.
Time scalability: Frame rates are hierarchized.
SNR (Signal to Noise Ratio) scalability: SN ratios are hierarchized.

Further, though not yet adopted in the standard, the bit depth scalability and chroma format scalability are also discussed.

A plurality of layers encoded in the scalable video coding generally reflects a common scene. The fact that a plurality of streams is encoded for a common scene applies not only to the scalable video coding, but also to multi-view coding for stereoscopic images and interlaced coding.

### CITATION LIST

### Non-Patent Literature

Non-Patent Literature 1: Kemal Ugur, et al., “Description of video coding technology proposal by Tandberg, Nokia, Ericsson” (JCTVC-A119, April 2010)

### SUMMARY OF INVENTION

### Technical Problem

However, in image coding schemes such as the scalable video coding, multi-view coding, and interlaced coding, an encoder and a decoder disadvantageously consume a large amount of resources to encode and decode a plurality of encoded streams. If, for example, the above code number table should be held for each layer in the scalable video coding, a large amount of memory resources is needed for the code number tables and also the number of swap processes applying a load to the processor increases.

Therefore, it is desirable to provide a mechanism capable of efficiently using code number tables in an image coding scheme in which a plurality of streams is encoded.

### Solution to Problem

According to the present disclosure, there is provided an image processing apparatus including a code number table that holds a pair of a code number used in entropy coding and an index value of a syntax element, a first conversion section that converts a first code number associated with a codeword contained in an encoded stream of a first picture of two or more pictures corresponding to a common scene into a first index value by referring to the code number table, and a second conversion section that converts a second code number associated with a codeword contained in an encoded stream of a second picture of the two or more pictures into a second index value by referring to the code number table.

The image processing device mentioned above may be typically realized as an image decoding device that decodes an image.

According to the present disclosure, there is provided an image processing method including converting a first code number associated with a codeword contained in an encoded stream of a first picture of two or more pictures corresponding to a common scene into a first index value by referring to a code number table holding a pair of a code number used in entropy coding and an index value of a syntax element, and converting a second code number associated with a codeword contained in an encoded stream of a second picture of the two or more pictures into a second index value by referring to the code number table.

According to the present disclosure, there is provided an image processing apparatus including a code number table that holds a pair of a code number used in entropy coding and an index value of a syntax element, a first conversion section that converts a first index value to be encoded for a first picture of two or more pictures corresponding to a common scene into a first code number by referring to the code number table, and a second conversion section that converts a second index value to be encoded for a second picture of the two or more pictures into a second code number by referring to the code number table.

The image processing device mentioned above may be typically realized as an image encoding device that encodes an image.

According to the present disclosure, there is provided an image processing method including converting a first index value to be encoded for a first picture of two or more pictures corresponding to a common scene into a first code number by referring to a code number table holding a pair of a code number used in entropy coding and an index value of a syntax element, and converting a second index value to be encoded for a second picture of the two or more pictures into a second code number by referring to the code number table.

### Advantageous Effects of Invention

According to the technology in the present disclosure, code number tables can efficiently be used in an image coding scheme in which a plurality of streams is encoded.

### BRIEF DESCRIPTION OF DRAWINGS

FIG. 1 is an explanatory view illustrating scalable video coding.

FIG. 2 is a block diagram showing a schematic configuration of an image encoding device according to an embodiment.

FIG. 3 is a block diagram showing a schematic configuration of an image decoding device according to an embodiment.

FIG. 4 is a block diagram showing an example of the configuration of a first picture coding section and a second picture coding section shown in FIG. 2.

FIG. 5 is a block diagram showing an example of a detailed configuration of a lossless encoding section shown in FIG. 4.

FIG. 6 is an explanatory view illustrating an example of a code number table.

FIG. 7 is an explanatory view illustrating an example of a VLC table.

FIG. 8 is an explanatory view illustrating swapping of the code number table.

FIG. 9 is an explanatory view illustrating an example of syntax elements for which a common code number table can be used.

FIG. 10 is an explanatory view illustrating another example of syntax elements for which a common code number table can be used.

FIG. 11 is a flow chart showing an example of the flow of processes at the time of coding according to an embodiment.

FIG. 12 is a block diagram showing an example of the configuration of a first picture decoding section and a second picture decoding section shown in FIG. 3.

FIG. 13 is a block diagram showing an example of a detailed configuration of a lossless decoding section shown in FIG. 12.

FIG. 14 is a flow chart showing an example of the flow of processes at the time of decoding according to an embodiment.

FIG. 15 is an explanatory view illustrating the application of image encoding processes according to an embodiment to multi-view coding.

FIG. 16 is an explanatory view illustrating the application of image decoding processes according to an embodiment to multi-view coding.

FIG. 17 is a block diagram showing an example of a schematic configuration of a television.

FIG. 18 is a block diagram showing an example of a schematic configuration of a mobile phone.

FIG. 19 is a block diagram showing an example of a schematic configuration of a recording/reproduction device.

FIG. 20 is a block diagram showing an example of a schematic configuration of an image capturing device.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated description is omitted.

The description will be provided in the order shown below:

1. Overview

2. Configuration Example of Coding Section According to an Embodiment

3. Flow of Process at the Time of Encoding According to an Embodiment

4. Configuration Example of Decoding Section According to an Embodiment

5. Flow of Process at the Time of Decoding According to an Embodiment

6. Application to Various Image Coding Schemes

7. Application Example

8 Summary

### 1. Overview

In this section, an overview of an image encoding device and an image decoding device according to an embodiment will be provided by taking the application to the scalable video coding as an example. The configuration of these devices described herein is also applicable to the multi-view coding and the interlaced coding.

In the scalable video coding, a plurality of layers, each containing a series of images, is encoded. A base layer is a layer encoded first to represent roughest images. An encoded stream of the base layer may be independently decoded without decoding encoded streams of other layers. Layers other than the base layer are layers called enhancement layer representing finer images. Encoded streams of enhancement layers are encoded by using information contained in the encoded stream of the base layer. Therefore, to reproduce an image of an enhancement layer, encoded streams of both of the base layer and the enhancement layer are decoded. The number of layers handled in the scalable video coding may be any number equal to 2 or greater. When three layers or more are encoded, the lowest layer is the base layer and the remaining layers are enhancement layers. For an encoded stream of a higher enhancement layer, information contained in encoded streams of a lower enhancement layer and the base layer may be used for encoding and decoding. In this specification, of at least two layers having dependence, the layer on the side depended on is called a lower layer and the layer on the depending side is called an upper layer.

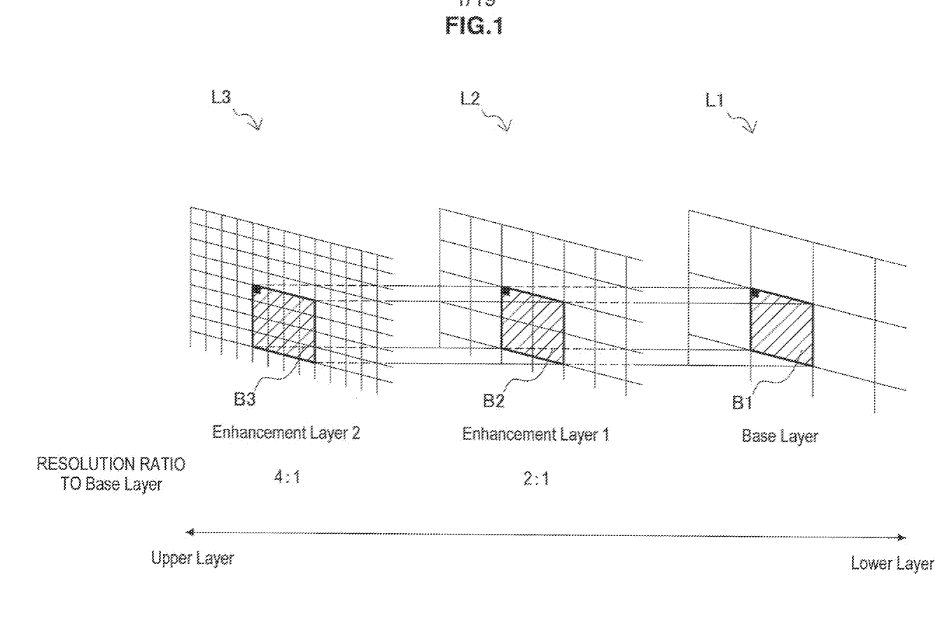

FIG. 1 shows three layers L1, L2, L3 subjected to scalable video coding. The layer L1 is the base layer and the layers L2, L3 are enhancement layers. Here, among various kinds of scalability, the space scalability is taken as an example. The ratio of spatial resolution of the layer L2 to the layer L1 is 2:1. The ratio of spatial resolution of the layer L3 to the layer L1 is 4:1. A block B1 of the layer L1 is a prediction unit inside a picture of the base layer. A block B2 of the layer L2 is a prediction unit inside a picture of an enhancement layer taking a scene common to the block B1. The block B2 corresponds to the block B1 of the layer L1. A block B3 of the layer L3 is a prediction unit inside a picture of a higher enhancement layer taking a scene common to the blocks B1 and B2. The block B3 corresponds to the block B1 of the layer L1 and the block B2 of the layer L2.

In such a layer structure, a spatial correlation and a temporal correlation of an image of some layer are normally similar to spatial correlations and temporal correlations of images of other layers corresponding to a common scene. If, for example, the block B1 has a strong correlation with a neighboring block in some direction in the layer L1, it is likely that the block B2 has a strong correlation with a neighboring block in the same direction in the layer L2 and the block B3 has a strong correlation with a neighboring block in the same direction in the layer L3. Therefore, tendencies of appearance of parameter values about intra prediction depending on spatial correlations of images and parameter values about inter prediction depending on temporal correlations of images (which parameter value appears more frequently) are similar to some extent between layers. Thus, when these parameters are entropy-encoded, it is expected that a parameter value with a higher appearance frequency can appropriately be mapped to a shorter codeword even if a code number table is made common between layers. Based on such an idea, in an embodiment described below, efficient use of resources in an image coding scheme in which a plurality of streams is encoded is realized by introducing a common code number table.

In the description that follows, a block of another layer corresponding to a block of some layer means, for example, a block of another layer having a pixel corresponding to a pixel in a predetermined position (for example, the upper left corner) inside a block of some layer. Based on such a definition, even if, for example, a block of an upper layer integrating a plurality of blocks of a lower layer is present, a block of a lower layer corresponding to a block of an upper layer can uniquely be decided.

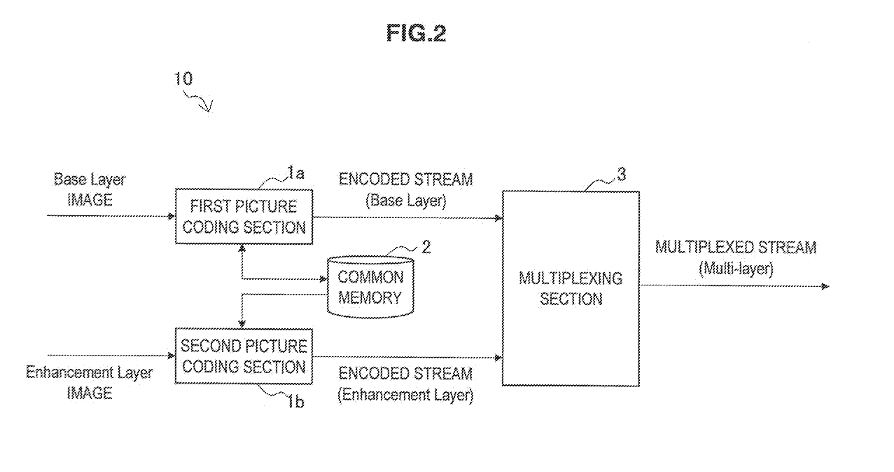

FIG. 2 is a block diagram showing a schematic configuration of an image encoding device 10 according to an embodiment supporting scalable video coding. Referring to FIG. 2, the image encoding device 10 includes a first picture coding section 1a, a second picture coding section 1b, a common memory 2 and a multiplexing section 3.

The first picture coding section 1a encodes a base layer image to generate an encoded stream of the base layer. The second picture coding section 1b encodes an enhancement layer image to generate an encoded stream of an enhancement layer. The common memory 2 stores information used in common between layers. The multiplexing section 3 multiplexes an encoded stream of the base layer generated by the first picture coding section 1a and encoded streams of one or more enhancement layers generated by the second picture coding section 1b to generate a multilayer multiplexed stream.

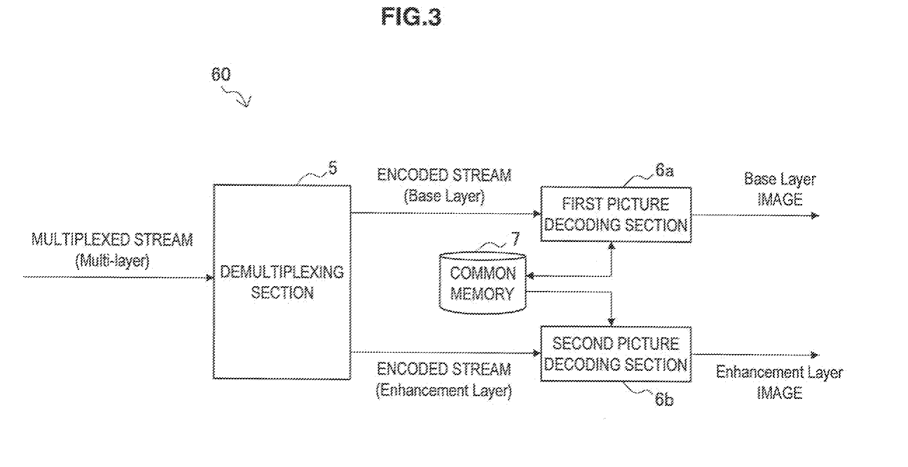

FIG. 3 is a block diagram showing a schematic configuration of an image decoding device 60 according to an embodiment supporting scalable video coding. Referring to FIG. 3, the image decoding device 60 includes a demultiplexing section 5, a first picture decoding section 6a, a second picture decoding section 6b, and a common memory 7.

The demultiplexing section 5 demultiplexes a multilayer multiplexed stream into an encoded stream of the base layer and encoded streams of one or more enhancement layers. The first picture decoding section 6a decodes an encoded stream of the base layer into a base layer image. The second picture decoding section 6b decodes an encoded stream of an enhancement layer into an enhancement layer image. The common memory 7 stores information used in common between layers.

In the image encoding device 10 illustrated in FIG. 2, the configuration of the first picture coding section 1a to encode the base layer and the configuration of the second picture coding section 1b to encode an enhancement layer are similar to each other. The first picture coding section 1a and the second picture coding section 1b refer to a common code number table stored in the common memory 2 to encode parameters of the predetermined type. Swapping of entries of the common code number table is not repeated for each layer. In the next section, the configuration of the first picture coding section 1a and the second picture coding section 1b will be described in detail.

Similarly in the image decoding device 60 illustrated in FIG. 3, the configuration of the first picture decoding section 6a to decode the base layer and the configuration of the second picture decoding section 6b to decode an enhancement layer are similar to each other. The first picture decoding section 6a and the second picture decoding section 6b refer to a common code number table stored in the common memory 7 to encode parameters of the predetermined type. Swapping of entries of the common code number table is not repeated for each layer. Further in the next section, the configuration of the first picture decoding section 6a and the second picture decoding section 6b will be described in detail.

### 2. Configuration Example of Coding Section According to an Embodiment

[2-1. Overall Configuration Example]

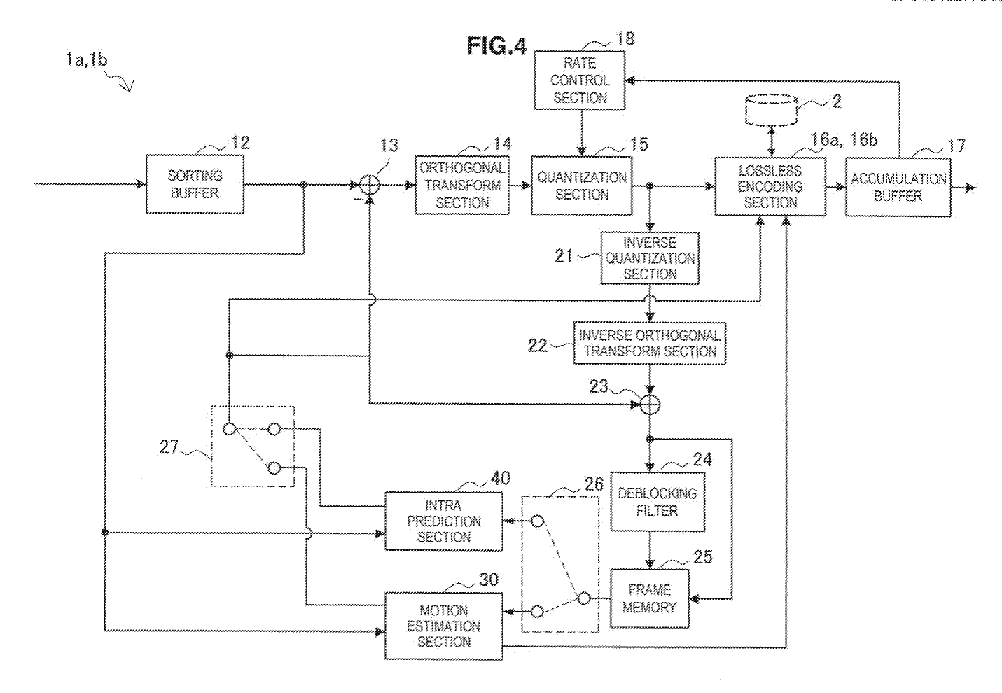

FIG. 4 is a block diagram showing an example of the configuration of the first picture coding section 1a and the second picture coding section 1b shown in FIG. 2. Referring to FIG. 4, the first picture coding section 1a includes a sorting buffer 12, a subtraction section 13, an orthogonal transform section 14, a quantization section 15, a lossless encoding section 16a, an accumulation buffer 17, a rate control section 18, an inverse quantization section 21, an inverse orthogonal transform section 22, an addition section 23, a deblocking filter 24, a frame memory 25, selectors 26, 27, a motion estimation section 30, and an intra prediction section 40. The second picture coding section 1b includes, instead of the lossless encoding section 16a, a lossless encoding section 16b.

The sorting buffer 12 sorts the images included in the series of image data. After sorting the images according to the a GOP (Group of Pictures) structure according to the encoding process, the sorting buffer 12 outputs the image data which has been sorted to the subtraction section 13, the motion estimation section 30 and the intra prediction section 40.

The image data input from the sorting buffer 12 and predicted image data input by the motion estimation section 30 or the intra prediction section 40 described later are supplied to the subtraction section 13. The subtraction section 13 calculates predicted error data which is a difference between the image data input from the sorting buffer 12 and the predicted image data and outputs the calculated predicted error data to the orthogonal transform section 14.

The orthogonal transform section 14 performs orthogonal transform on the predicted error data input from the subtraction section 13. The orthogonal transform to be performed by the orthogonal transform section 14 may be discrete cosine transform (DCT) or Karhunen-Loeve transform, for example. The orthogonal transform section 14 outputs transform coefficient data acquired by the orthogonal transform process to the quantization section 15.

The transform coefficient data input from the orthogonal transform section 14 and a rate control signal from the rate control section 18 described later are supplied to the quantization section 15. The quantization section 15 quantizes the transform coefficient data, and outputs the transform coefficient data which has been quantized (hereinafter, referred to as quantized data) to the lossless encoding section 16a or 16b and the inverse quantization section 21. Also, the quantization section 15 switches a quantization parameter (a quantization scale) based on the rate control signal from the rate control section 18 to thereby change the bit rate of the quantized data.

The lossless encoding section 16a generates an encoded stream of the base layer by performing a lossless encoding process on quantized data input from the quantization section 15. The lossless encoding section 16a also encodes information about an intra prediction or information about an inter prediction input from the selector 27 and multiplexes encoded parameters into the header region of an encoded stream. Then, the lossless encoding section 16a outputs the generated encoded stream to the accumulation buffer 17.

Similarly, the lossless encoding section 16b generates an encoded stream of an enhancement layer by performing a lossless encoding process on quantized data input from the quantization section 15. The lossless encoding section 16b also encodes information about an intra prediction or information about an inter prediction input from the selector 27 and multiplexes encoded parameters into the header region of an encoded stream. Then, the lossless encoding section 16b outputs the generated encoded stream to the accumulation buffer 17.

The accumulation buffer 17 temporarily accumulates an encoded stream input from the lossless encoding section 16a or 16b using a storage medium such as a semiconductor memory. Then, the accumulation buffer 17 outputs the accumulated encoded stream to a transmission section (not shown) (for example, a communication interface or an interface to peripheral devices) at a rate in accordance with the band of a transmission path.

The rate control section 18 monitors the free space of the accumulation buffer 17. Then, the rate control section 18 generates a rate control signal according to the free space on the accumulation buffer 17, and outputs the generated rate control signal to the quantization section 15. For example, when there is not much free space on the accumulation buffer 17, the rate control section 18 generates a rate control signal for lowering the bit rate of the quantized data. Also, for example, when the free space on the accumulation buffer 17 is sufficiently large, the rate control section 18 generates a rate control signal for increasing the bit rate of the quantized data.

The inverse quantization section 21 performs an inverse quantization process on the quantized data input from the quantization section 15. Then, the inverse quantization section 21 outputs transform coefficient data acquired by the inverse quantization process to the inverse orthogonal transform section 22.

The inverse orthogonal transform section 22 performs an inverse orthogonal transform process on the transform coefficient data input from the inverse quantization section 21 to thereby restore the predicted error data. Then, the inverse orthogonal transform section 22 outputs the restored predicted error data to the addition section 23.

The addition section 23 adds the restored predicted error data input from the inverse orthogonal transform section 22 and the predicted image data input from the motion estimation section 30 or the intra prediction section 40 to thereby generate decoded image data. Then, the addition section 23 outputs the generated decoded image data to the deblocking filter 24 and the frame memory 25.

The deblocking filter 24 performs a filtering process for reducing block distortion occurring at the time of encoding of an image. The deblocking filter 24 filters the decoded image data input from the addition section 23 to remove the block distortion, and outputs the decoded image data after filtering to the frame memory 25.

The frame memory 25 stores, using a storage medium, the decoded image data input from the addition section 23 and the decoded image data after filtering input from the deblocking filter 24.

The selector 26 reads the decoded image data after filtering which is to be used for inter prediction from the frame memory 25, and supplies the decoded image data which has been read to the motion estimation section 30 as reference image data. Also, the selector 26 reads the decoded image data before filtering which is to be used for intra prediction from the frame memory 25, and supplies the decoded image data which has been read to the intra prediction section 40 as reference image data.

In the inter prediction mode, the selector 27 outputs predicted image data as a result of inter prediction output from the motion estimation section 30 to the subtraction section 13 and also outputs information about the inter prediction to the lossless encoding section 16a or 16b. In the intra prediction mode, the selector 27 outputs predicted image data as a result of intra prediction output from the intra prediction section 40 to the subtraction section 13 and also outputs information about the intra prediction to the lossless encoding section 16a or 16b. The selector 27 switches the inter prediction mode and the intra prediction mode in accordance with the magnitude of a cost function value output from the motion estimation section 30 and the intra prediction section 40.

The motion estimation section 30 performs an inter prediction process (inter-frame prediction process) based on image data (original image data) to be encoded and input from the sorting buffer 12 and decoded image data supplied via the selector 26. For example, the motion estimation section 30 evaluates prediction results in each prediction mode using a predetermined cost function. Next, the motion estimation section 30 selects the prediction mode in which the cost function value takes the minimum value, that is, the prediction mode in which the compression rate is the highest as the optimum prediction mode. Also, the motion estimation section 30 generates predicted image data according to the optimum prediction mode. Then, the motion estimation section 30 outputs prediction mode information indicating the selected optimum prediction mode, information about the inter prediction including motion vector information and reference pixel information, the cost function value, and predicted image data to the selector 27.

The intra prediction section 40 performs an intra prediction process in prediction units based on original image data input from the sorting buffer 12 and decoded image data as reference image data supplied from the frame memory 25. For example, the intra prediction section 40 evaluates a prediction result in each prediction mode by using a predetermined cost function. Next, the intra prediction section 40 selects the prediction mode in which the cost function takes on the minimum value, that is, the prediction mode in which the compression rate is the highest as the optimum prediction mode. The intra prediction section 40 generates predicted image data according to the optimum prediction mode. Then, the intra prediction section 40 outputs information about inter prediction including prediction mode information representing the selected optimum prediction mode, the cost function value, and predicted image data to the selector 27.

The first picture coding section 1a performs a series of encoding processes described here on a sequence of image data of the base layer. The second picture coding section 1b performs a series of encoding processes described here on a sequence of image data of an enhancement layer. Encoding processes for the base layer and those for the enhancement layer are performed, as will further be described below, in synchronization in prediction units. When a plurality of enhancement layers is present, encoding processes for the base layer and those for the plurality of enhancement layers may be performed in synchronization in prediction units.

[2-2. Configuration Example of Lossless Coding Section]

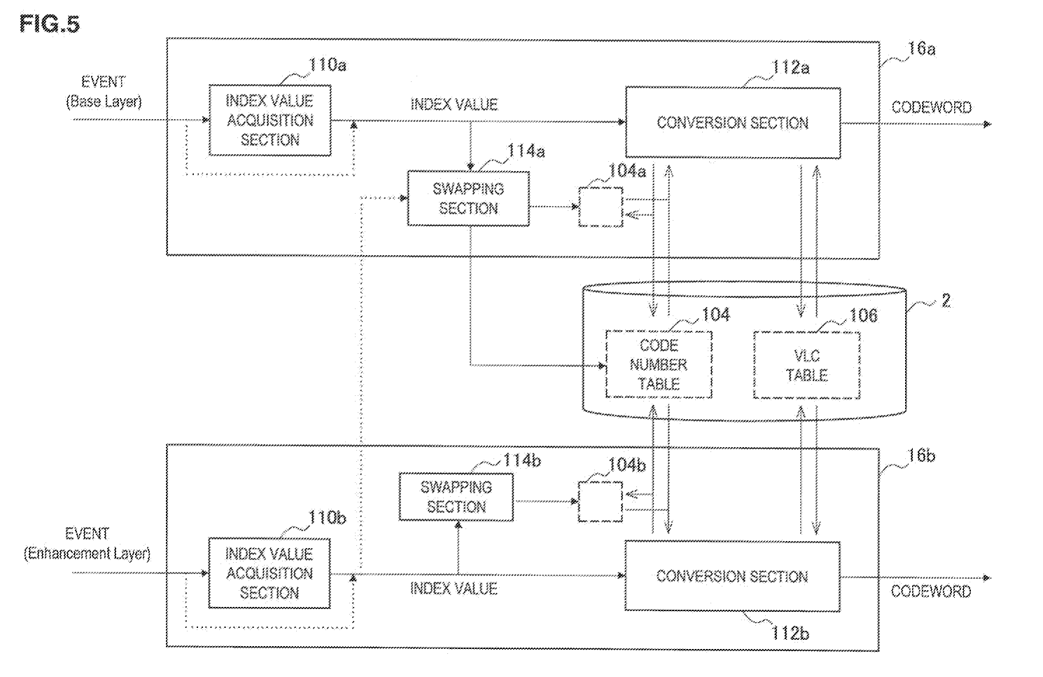

FIG. 5 is a block diagram showing an example of a detailed configuration of the lossless encoding sections 16a, 16b shown in FIG. 4. Referring to FIG. 5, the lossless encoding section 16a includes an index value acquisition section 110a, a conversion section 112a, and a swapping section 114a. The lossless encoding section 16b includes an index value acquisition section 110b, a conversion section 112b, and a swapping section 114b.

The conversion section 112a refers to a code number table 104 and a VLC (Variable Length Code) table 106 stored in the common memory 2. The conversion section 112b also refers to the code number table 104 and the VLC table 106. The conversion section 112a can also refer to a layer specific code number table 104a. The conversion section 112b can also refer to a layer specific code number table 104b.

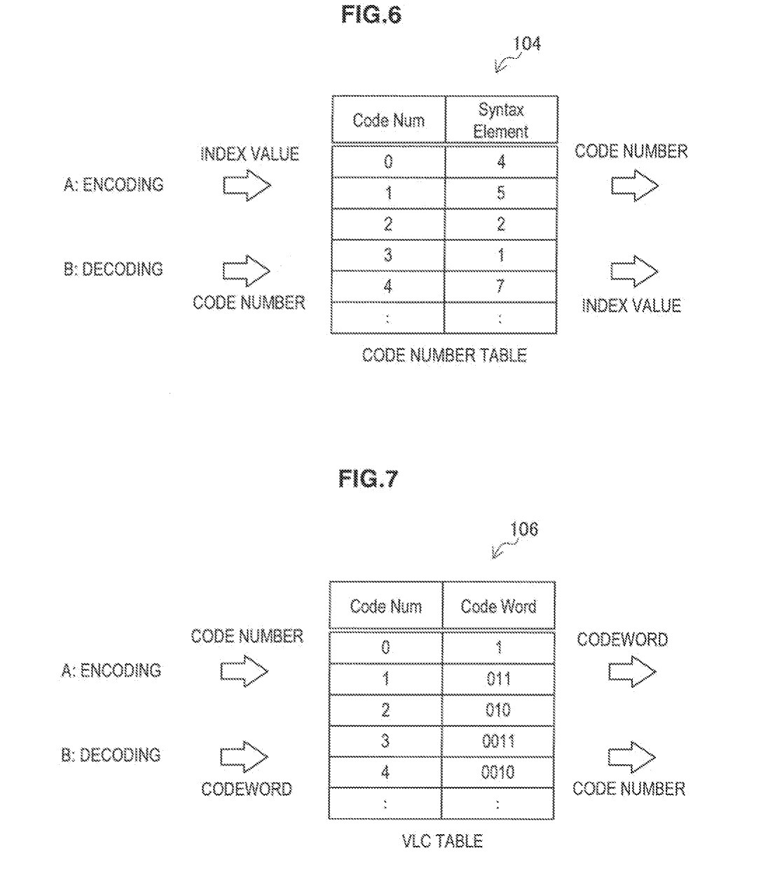

FIG. 6 is an explanatory view illustrating an example of the code number table. The code number table 104 has two data items of the code number (CodeNum) and the syntax element (SyntaxElement). The code number is a number associated with each codeword used in entropy coding. For example, the code number may be integers from 0 to the number of candidates of codewords (minus 1). The value of a syntax element of the code number table 104 is an index value corresponding to each syntax element. The index value of a syntax element is also called a table index.

By referring to the code number table 104 described above, when, for example, an image is encoded, the code number corresponding to an appearing index value is acquired for each syntax element. In the example of FIG. 3, the code number table 104 contains (0, 4), (1, 5), (2, 2), (3, 1), (4, 7), . . . as pairs of the code number and the index value of a syntax element. Thus, if the appearing index value is, for example, “4”, the code number “0” is acquired. If the appearing index value is “5”, the code number “1” is acquired. When an image is decoded, the index value corresponding to an appearing code number is acquired for each syntax element. If the appearing code number is, for example, “0”, the index value “4” is acquired. If the appearing code number is “1”, the index value “5” is acquired.

Typically, a different code number table is provided for each type of syntax elements. In the present embodiment, code number tables of predetermined types of syntax elements are made common between layers to constitute the individual code number tables 104. The predetermined type may include prediction mode information for intra prediction, prediction mode information for inter prediction, and reference image information. A code number table for other types of syntax elements may be made common between layers. FIG. 5 shows the one common code number table 104 for convenience sake, but actually, a plurality of the common code number tables 104 may be present. Code number tables for other types of syntax elements are provided for each layer and constitute a code number table 104a and a code number table 104b specific to each layer.

FIG. 7 is an explanatory view illustrating an example of the VLC table. The VLC table 106 has two data items of the code number (CodeNum) and the codeword (CodeWord). The codeword is a variable-length bit string defined by associating with the code number. In the VLC table 106, typically a shorter bit string is associated with a smaller code number. By referring to the VLC table 106 as described above, when, for example, an image is encoded, the codeword associated with the code number corresponding to the appearing index value is acquired from the VLC table 106 and the acquired codeword is output as a portion of an encoded stream. When an image is decoded, the code number associated with a codeword contained in an encoded stream is acquired from the VLC table 106 and the acquired codeword is used to refer to the code number table 104.

In, for example, H.264/AVC and HEVC, a plurality of VLC tables with different codeword patterns is provided in advance. Then, the VLC table to be used at the time of encoding/decoding is switched in accordance with the distribution of the appearance probability of index values. However, differences of codeword patterns in the VLC table are not associated with features of the present embodiment and so a detailed description of switching of the VLC table is omitted here.

Using a group of tables as described above, the lossless encoding section 16a converts image data and parameters of the base layer into a codeword for each syntax element.

More specifically, the index value acquisition section 110a first recognizes an input event and acquires the index value of each syntax element corresponding to the recognized event (such a process is also called “enumeration”). The input data for some syntax elements already takes the form of index value and so “enumeration” is omitted.

The conversion section 112a converts each acquired index value into the code number by referring to the code number table 104 or 104a. If the type of the syntax element is contained in the predetermined types, the common code number table 104 is referred to. On the other hand, if the type of a syntax element is not contained in the predetermined types, the layer specific code number table 104a is referred to. The conversion section 112a further converts the code number into the codeword by referring to the VLC table 106. Then, the conversion section 112a successively outputs the acquired codeword as a portion of an encoded stream.

The swapping section 114a swaps entries of the code number tables 104, 104a in accordance with the index value appearing in the input into the conversion section 112a to cause content of each code number table to follow occurrence frequency changes of the index value. Accordingly, a shorter codeword will appropriately be used for an index value with a higher occurrence frequency. More specifically, an occurring index value and an index value immediately above (that is, an index value whose code number is smaller by 1) are swapped in the code number table.

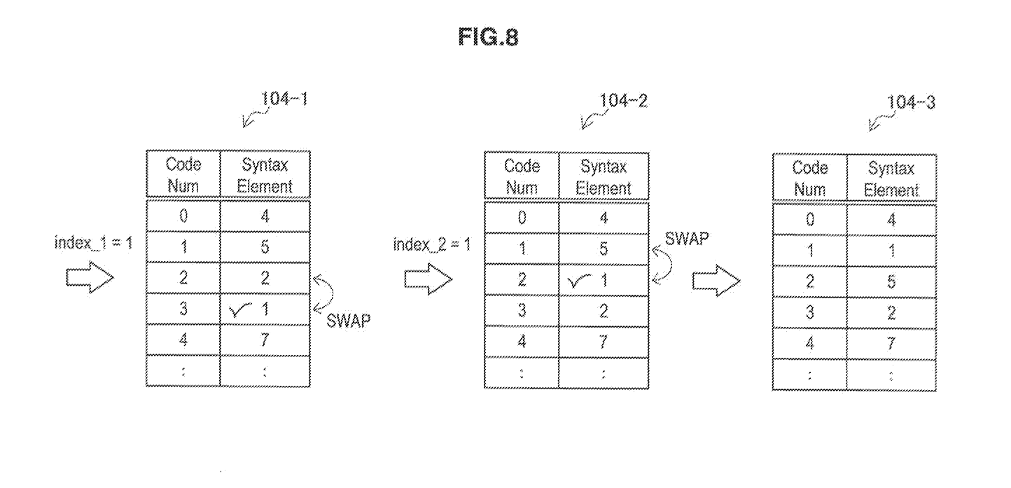

FIG. 8 is an explanatory view illustrating swapping of the code number table described in the contributed article JCTVC-A119. Referring to FIG. 8, code number tables 104-1 to 104-3 updated successively by swapping are shown. First, the index value (index_{—}1) occurring first is “1”. In the code number table 104-1, the index value corresponds to the code number “3”. Thus, the index values “1” and “2” corresponding to the code number “3” and the code number “2” above that respectively are swapped. The index value (index_{—}2) occurring next is also “1”. In the code number table 104-2, the index value corresponds to the code number “2”. Thus, the index values “5” and “1” corresponding to the code number “2” and the code number “1” above that respectively are swapped. As a result, in the code number table 104-3, the index value “1” corresponds to the code number “1”, which is smaller than in the previous state.

Like the lossless encoding section 16a, the lossless encoding section 16b converts image data and parameters of an enhancement layer into a codeword for each syntax element by using a group of tables as described above.

More specifically, the index value acquisition section 110b first recognizes an input event and acquires the index value of each syntax element corresponding to the recognized event. The input data for some syntax elements already takes the form of index value and so “enumeration” is omitted.

The conversion section 112b converts each acquired index value into the code number by referring to the code number table 104 or 104b. If the type of the syntax element is contained in the predetermined types, the common code number table 104 is referred to. On the other hand, if the type of a syntax element is not contained in the predetermined types, the layer specific code number table 104b is referred to. The conversion section 112b further converts the code number into the codeword by referring to the VLC table 106. Then, the conversion section 112b successively outputs the acquired codeword as a portion of an encoded stream.

The swapping section 114b swaps entries of the layer specific code number table 104b in accordance with the index value appearing in the input into the conversion section 112b. The swapping section 114b does not swap entries of the common code number table 104. Entries of the common code number table 104 are swapped by the swapping section 114a of the lossless encoding section 16a. Entries of the common code number table 104 can once be swapped for each syntax element of the predetermined types after the index value of the base layer is converted into the code number and the index value of enhancement layers is converted into the code number.

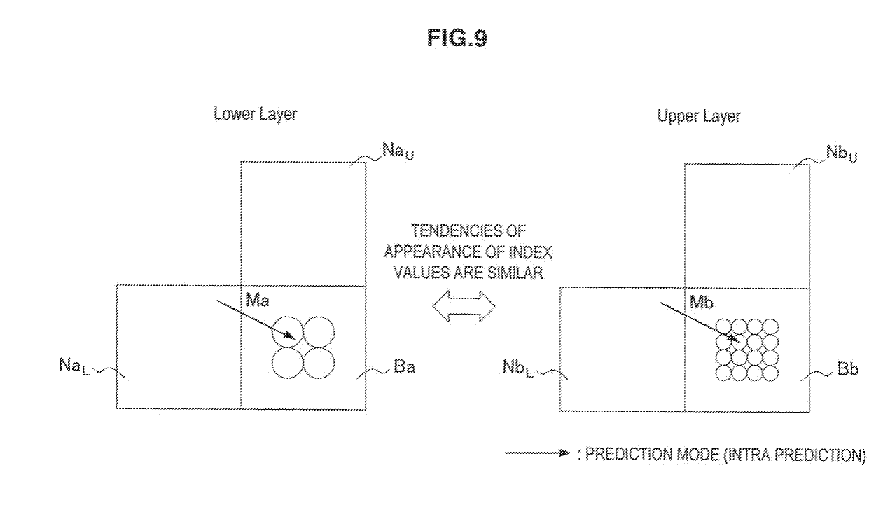

FIG. 9 is an explanatory view illustrating an example of syntax elements for which a common code number table can be used. A prediction unit Ba of a lower layer and neighboring blocks Na_{U}, Na_{L} adjacent to the prediction unit Ba are shown on the left side of FIG. 9. The prediction unit Ba is assumed to be the prediction unit of intra prediction blocks. A prediction mode Ma for intra prediction is set to the prediction unit Ba. A prediction unit Bb of an upper layer and neighboring blocks Nb_{U}, Nb_{L} adjacent to the prediction unit Bb are shown on the right side of FIG. 9. The prediction unit Bb is assumed to be the prediction unit of intra prediction blocks. A prediction mode Mb for intra prediction is set to the prediction unit Bb. For example, in space scalability, SNR scalability, and bit depth scalability, spatial correlations of images are similar between layers. Therefore, prediction directions of the prediction mode Ma and the prediction mode Mb are likely to be equal to each other. This means that tendencies of appearance of index values of prediction mode information for intra prediction are similar between layers. Therefore, it is useful to adopt the common code number table 104 as shown in FIG. 5 regarding prediction mode information for intra prediction.

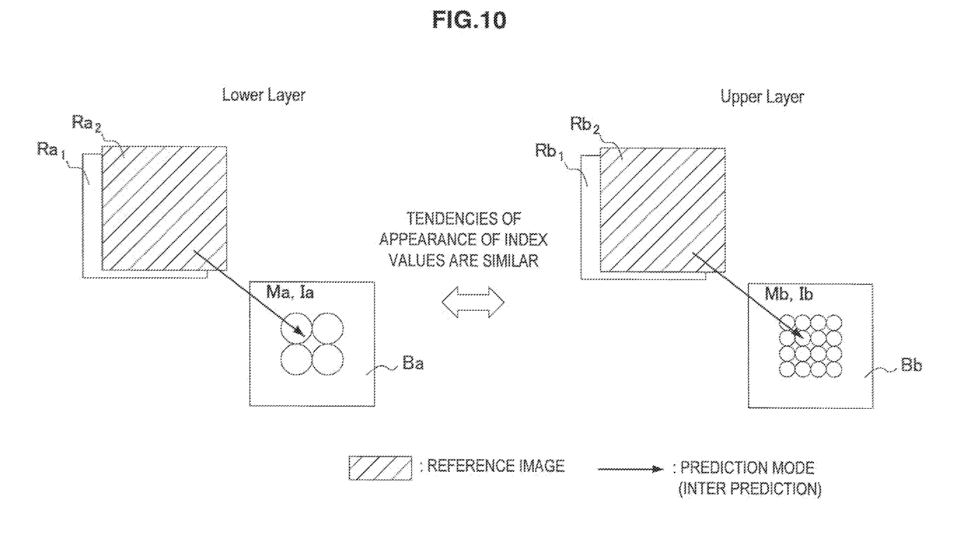

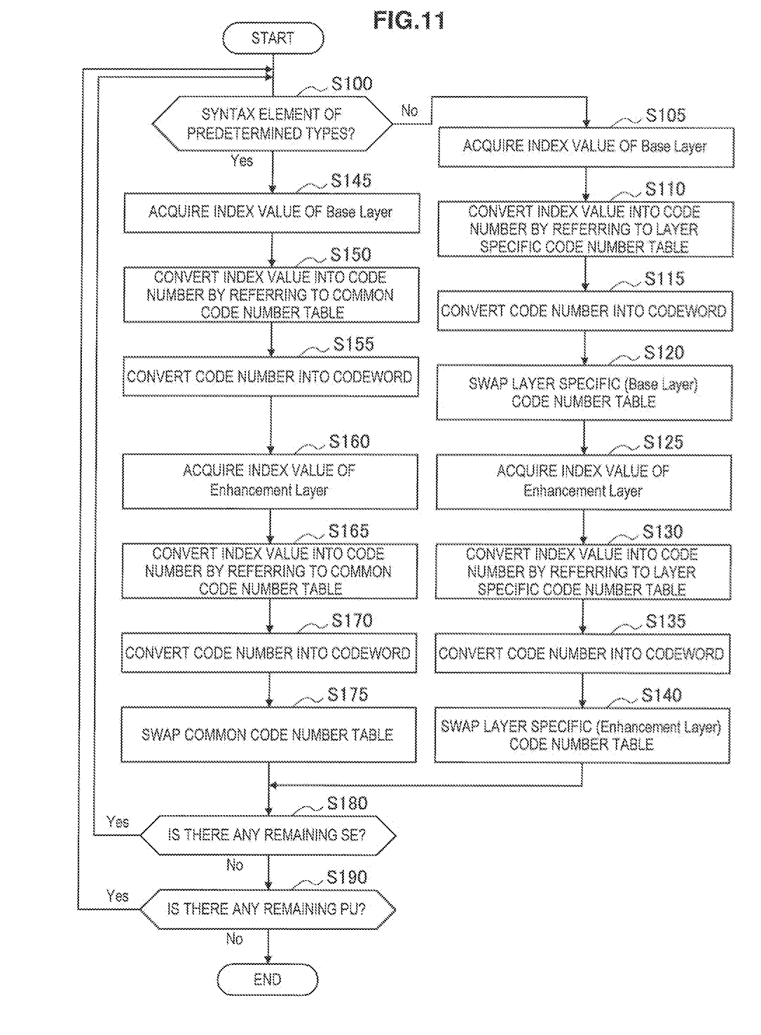

FIG. 10 is an explanatory view illustrating another example of syntax elements for which a common code number table can be used. A prediction unit Ba of a lower layer and a plurality of reference image candidates Ra₁, Ra₂ are shown on the left side of FIG. 10. The prediction unit Ba is assumed to be the prediction unit of inter prediction blocks. A prediction mode Ma for inter prediction is set to the prediction unit Ba. A reference image indicator Ia indicates the reference image candidate Ra₂. A prediction unit Bb of an upper layer and a plurality of reference image candidates Rb₁, Rb₂ are shown on the right side of FIG. 10. The prediction unit Bb is assumed to be the prediction unit of inter prediction blocks. A prediction mode Mb for inter prediction is set to the prediction unit Bb. A reference image indicator Ib indicates the reference image candidate Rb₂. For example, in space scalability, SNR scalability, and bit depth scalability, temporal correlations of images are similar between layers. Therefore, the prediction modes Ma, Mb are likely to be equal to each other and also the reference image indicators Ia, Ib are likely to be equal to each other. This means that tendencies of appearance of index values of prediction mode information for inter prediction and reference image information are similar between layers. Therefore, it is useful to adopt the common code number table 104 as shown in FIG. 5 regarding syntax elements of such types.

By adopting the common code number table 104 as described above, memory resources needed to store tables can be saved without substantially decreasing the coding efficiency.

### 3. Flow of Process at the Time of Encoding According to an Embodiment

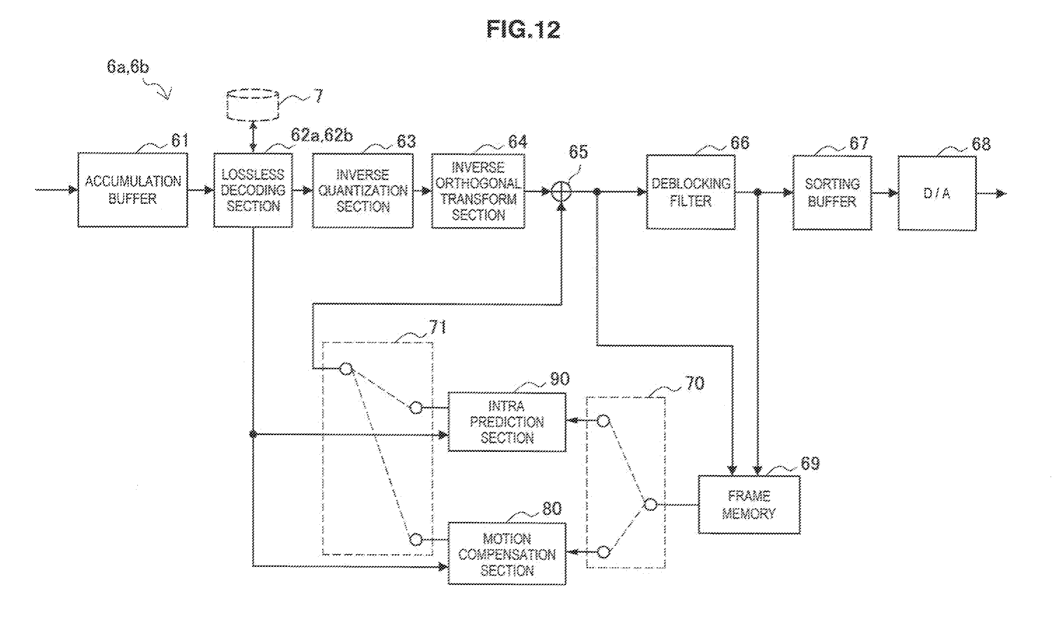

FIG. 11 is a flow chart showing an example of the flow of processes at the time of coding according to the present embodiment. Processes shown in FIG. 11 are performed in mutually corresponding prediction units of the base layer and an enhancement layer. Processes of steps S100 to S180 are performed for each syntax element.

Referring to FIG. 11, processes are first switched depending on whether the syntax element to be processed is a syntax element of the predetermined types (step S100). If, for example, the syntax element to be processed is prediction mode information for intra prediction, prediction mode information for inter prediction, or reference image information, the process proceeds to step S145. Otherwise, the process proceeds to step S105.

Processes in steps S105 to S140 are processes when a layer specific code number table is referred to.

First, the index value acquisition section 110a acquires the index value of the base layer of the syntax element to be processed (step S105). Next, the conversion section 112a converts the index value acquired by the index value acquisition section 110a into the code number by referring to the layer specific code number table 104a (step S110). Next, the conversion section 112a converts the code number into the codeword by referring to the VLC table 106 (step S115). Next, the swapping section 114a swaps the entry corresponding to the appearing index value in the layer specific code number table 104a (step S120).

Also, the index value acquisition section 110b acquires the index value of an enhancement layer of the syntax element to be processed (step S125). Next, the conversion section 112b converts the index value acquired by the index value acquisition section 110b into the code number by referring to the layer specific code number table 104b (step S130). Next, the conversion section 112b converts the code number into the codeword by referring to the VLC table 106 (step S135). Next, the swapping section 114b swaps the entry corresponding to the appearing index value in the layer specific code number table 104b (step S140).

Processes in steps S145 to S175 are processes when a common code number table is referred to.

First, the index value acquisition section 110a acquires the index value of the base layer of the syntax element to be processed (step S145). Next, the conversion section 112a converts the index value acquired by the index value acquisition section 110a into the code number by referring to the common code number table 104 (step S150). Next, the conversion section 112a converts the code number into the codeword by referring to the VLC table 106 (step S155).

Also, the index value acquisition section 110b acquires the index value of an enhancement layer of the syntax element to be processed (step S160). Next, the conversion section 112b converts the index value acquired by the index value acquisition section 110b into the code number by referring to the common code number table 104 (step S165). Next, the conversion section 112b converts the code number into the codeword by referring to the VLC table 106 (step S170).

Then, the swapping section 114a swaps the entry corresponding to the index value appearing in the input in the conversion section 112a inside the common code number table 104 (step S175).

If, after these processes for the syntax element to be processed are completed, any syntax element not yet processed remains in the prediction unit, the process returns to step S100 (step S180). On the other hand, no syntax element not yet processed remains, whether any remaining prediction unit is present is determined (S190). If, a still remaining prediction unit is present, the process returns to step S100 to repeat the above processes for the next prediction unit. If no remaining prediction unit is present, the flow chart in FIG. 11 terminates.

### 4. Configuration Example of Decoding Section According to an Embodiment

[4-1. Overall Configuration Example]

FIG. 12 is a block diagram showing an example of the configuration of the first picture decoding section 6a and the second picture decoding section 6b shown in FIG. 3. Referring to FIG. 12, the first picture decoding section 6a includes an accumulation buffer 61, a lossless decoding section 62a, an inverse quantization section 63, an inverse orthogonal transform section 64, an addition section 65, a deblocking filter 66, a sorting buffer 67, a D/A (Digital to Analogue) conversion section 68, a frame memory 69, selectors 70, 71, a motion compensation section 80, and an intra prediction section 90. The second picture decoding section 6b includes, instead of the lossless decoding section 62a, a lossless decoding section 62b.

The accumulation buffer 61 temporarily accumulates an encoded stream input via a transmission path using a storage medium.

The lossless decoding section 62a decodes an encoded stream of the base layer input from the accumulation buffer 61 according to the coding scheme used at the time of encoding. The lossless decoding section 62a also decodes information multiplexed in the header region of the encoded stream. The information decoded by the lossless decoding section 62a may contain, for example, the information about inter prediction and the information about intra prediction described above. The lossless decoding section 62a outputs the information about inter prediction to the motion compensation section 80. The lossless decoding section 62a also outputs the information about intra prediction to the intra prediction section 90.

Similarly, the lossless decoding section 62b decodes an encoded stream of an enhancement layer input from the accumulation buffer 61 according to the coding scheme used at the time of encoding. The lossless decoding section 62b also decodes information multiplexed in the header region of the encoded stream. The information decoded by the lossless decoding section 62b may contain, for example, the information about inter prediction and the information about intra prediction described above. The lossless decoding section 62b outputs the information about inter prediction to the motion compensation section 80. The lossless decoding section 62b also outputs the information about intra prediction to the intra prediction section 90.

The inverse quantization section 63 inversely quantizes quantized data which has been decoded by the lossless decoding section 62a or 62b. The inverse orthogonal transform section 64 generates predicted error data by performing inverse orthogonal transformation on transform coefficient data input from the inverse quantization section 63 according to the orthogonal transformation method used at the time of encoding. Then, the inverse orthogonal transform section 64 outputs the generated predicted error data to the addition section 65.

The addition section 65 adds the predicted error data input from the inverse orthogonal transform section 64 and predicted image data input from the selector 71 to thereby generate decoded image data. Then, the addition section 65 outputs the generated decoded image data to the deblocking filter 66 and the frame memory 69.

The deblocking filter 66 removes block distortion by filtering the decoded image data input from the addition section 65, and outputs the decoded image data after filtering to the sorting buffer 67 and the frame memory 69.

The sorting buffer 67 generates a series of image data in a time sequence by sorting images input from the deblocking filter 66. Then, the sorting buffer 67 outputs the generated image data to the D/A conversion section 68.

The D/A conversion section 68 converts the image data in a digital format input from the sorting buffer 67 into an image signal in an analogue format. Then, the D/A conversion section 68 causes an image to be displayed by outputting the analogue image signal to a display (not shown) connected to the image decoding device 60, for example.

The frame memory 69 stores, using a storage medium, the decoded image data before filtering input from the addition section 65, and the decoded image data after filtering input from the deblocking filter 66.

The selector 70 switches the output destination of the image data from the frame memory 69 between the motion compensation section 80 and the intra prediction section 90 for each block in the image according to mode information acquired by the lossless decoding section 62a or 62b. For example, in the case the inter prediction mode is specified, the selector 70 outputs the decoded image data after filtering that is supplied from the frame memory 69 to the motion compensation section 80 as the reference image data. Also, in the case the intra prediction mode is specified, the selector 70 outputs the decoded image data before filtering that is supplied from the frame memory 69 to the intra prediction section 90 as reference image data.

The selector 71 switches the output source of predicted image data to be supplied to the addition section 65 between the motion compensation section 80 and the intra prediction section 90 according to the mode information acquired by the lossless decoding section 62a or 62b. For example, in the case the inter prediction mode is specified, the selector 71 supplies to the addition section 65 the predicted image data output from the motion compensation section 80. Also, in the case the intra prediction mode is specified, the selector 71 supplies to the addition section 65 the predicted image data output from the intra prediction section 90.

The motion compensation section 80 performs a motion compensation process based on the information about inter prediction input from the lossless decoding section 62a or 62b and the reference image data from the frame memory 69, and generates predicted image data. Then, the motion compensation section 80 outputs the generated predicted image data to the selector 71.

The intra prediction section 90 performs an intra prediction process based on information about intra predictions input from the lossless decoding section 62a or 62b and reference image data from the frame memory 69 and generates predicted image data. Then, the intra prediction section 90 outputs generated predicted image data to the selector 71.

The first picture decoding section 6a performs a series of decoding processes described here on a sequence of image data of the base layer. The second picture decoding section 6b performs a series of decoding processes described here on a sequence of image data of an enhancement layer. Decoding processes for the base layer and those for the enhancement layer are performed, as will further be described below, in synchronization in prediction units. When a plurality of enhancement layers is present, decoding processes for the base layer and those for the plurality of enhancement layers may be performed in synchronization in prediction units.

[4-2. Configuration Example of Lossless Decoding Section]

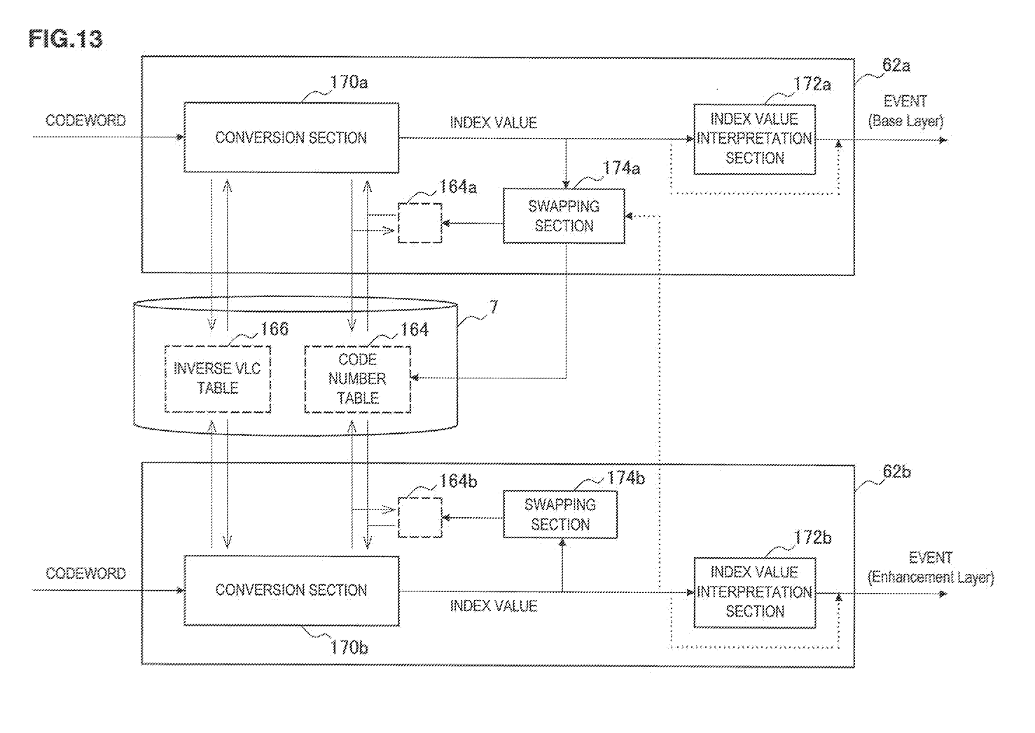

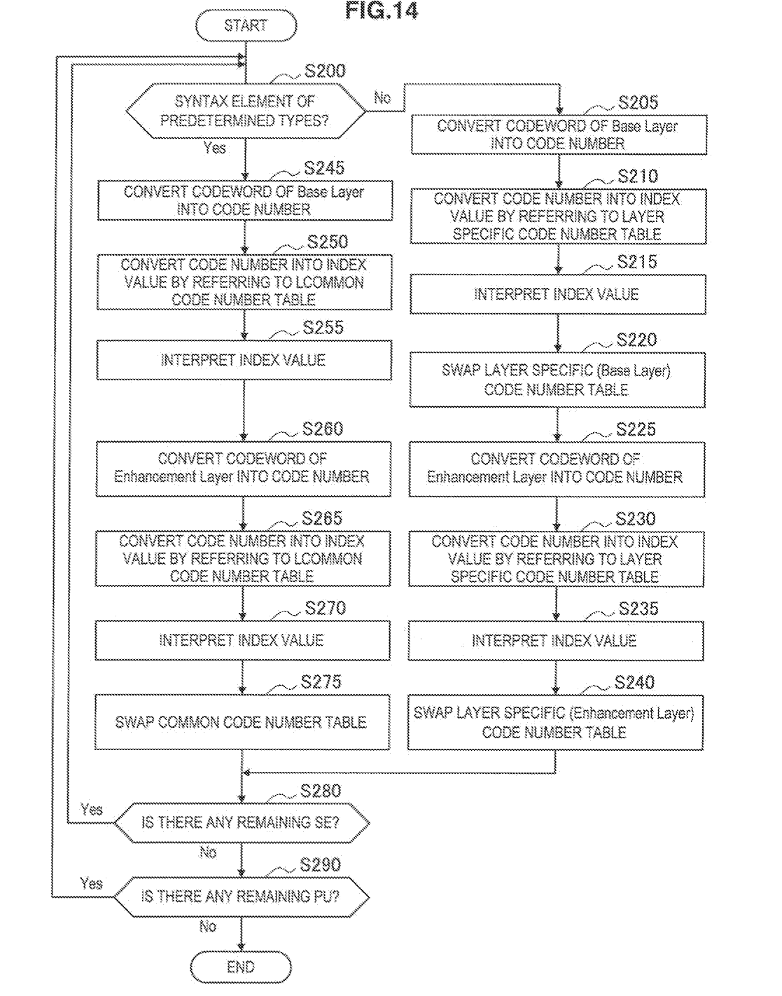

FIG. 13 is a block diagram showing an example of a detailed configuration of the lossless decoding sections 62a, 62b shown in FIG. 12. Referring to FIG. 13, the lossless decoding section 62a includes a conversion section 170a, and an index value interpretation section 172a, and a swapping section 174a. The lossless decoding section 62b includes a conversion section 170b, and an index value interpretation section 172b, and a swapping section 174b.

The conversion section 170a refers to a code number table 164 and an inverse VLC table 166 stored in the common memory 7. Also, the conversion section 170b refers to the code number table 164 and the inverse VLC table 166. The conversion section 170a may also refer to a layer specific code number table 164a. The conversion section 170b may also refer to a layer specific code number table 164b.

Using a group of tables described above, the lossless decoding section 62a converts codewords of an encoded stream of the base layer into image data and parameters for each syntax element.

More specifically, the conversion section 170a converts a codeword acquired from an encoded stream into a code number by referring to the inverse VLC table 166. The conversion section 170a also converts the acquired code number into an index value by referring to the code number table 164 or 164a. If the type of the syntax element is contained in the predetermined types, the common code number table 164 is referred to. On the other hand, if the type of the syntax element is not contained in the predetermined types, the layer specific code number table 164a is referred to.

The index value interpretation section 172a interprets the index value input from the conversion section 170a syntax element by syntax element and outputs data representing the corresponding event (such a process is also called “inverse enumeration”). “inverse enumeration” may be omitted for some syntax elements so that the input index value is directly output.

The swapping section 174a swaps entries of the code number tables 164, 164a in accordance with the index value appearing in the output from the conversion section 170a.

Like the lossless decoding section 62a, the lossless decoding section 62b converts a codeword of an encoded stream of an enhancement layer into an image data and parameters for each syntax element by using a group of tables as described above.

More specifically, the conversion section 170b first converts a codeword acquired from an encoded stream into a code number by referring to the inverse VLC table 166. The conversion section 170b also converts the acquired code number into an index value by referring to the code number table 164 or 164b. If the type of the syntax element is contained in the predetermined types, the common code number table 164 is referred to. On the other hand, if the type of the syntax element is not contained in the predetermined types, the layer specific code number table 164b is referred to.

The index value interpretation section 172b interprets the index value input from the conversion section 170b syntax element by syntax element and outputs data representing the corresponding event. “inverse enumeration” may be omitted for some syntax elements so that the input index value is directly output.

The swapping section 174b swaps entries of the layer specific code number table 164b in accordance with the index value appearing in the output from the conversion section 170b. The swapping section 174b does not swap entries of the common code number table 164. Entries of the common code number table 164 are swapped by the swapping section 174a of the lossless decoding section 62a. Entries of the common code number table 164 can once be swapped for each syntax element of the predetermined types after the code number of the base layer is converted into the index value and the code number of enhancement layers is converted into the index value.

### 5. Flow of Process at the Time of Decoding According to an Embodiment

FIG. 14 is a flow chart showing an example of the flow of processes at the time of decoding according to an embodiment. Processes shown in FIG. 14 are performed in mutually corresponding prediction units of the base layer and an enhancement layer. Processes of steps S200 to S280 are performed for each syntax element.

Referring to FIG. 14, processes are first switched depending on whether the syntax element to be processed is a syntax element of the predetermined types (step S200). If, for example, the syntax element to be processed is prediction mode information for intra prediction, prediction mode information for inter prediction, or reference image information, the process proceeds to step S245. Otherwise, the process proceeds to step S205.

Processes in steps S205 to S240 are processes when a layer specific code number table is referred to.

First, the conversion section 170a converts a codeword of the base layer into a code number by referring to the VLC table 166 (step S205). Next, the conversion section 170a converts the code number into an index value by referring to the layer specific code number table 164a (step S210). Next, the index value interpretation section 172a interprets the index value input from the conversion section 170a and outputs data representing the corresponding event (step S215). Next, the swapping section 174a swaps the entry corresponding to the appearing index value in the layer specific code number table 164a (step S220).

Also, the conversion section 170b converts a codeword of an enhancement layer into a code number by referring to the VLC table 166 (step S225). Next, the conversion section 170b converts the code number into an index value by referring to the layer specific code number table 164b (step S230). Next, the index value interpretation section 172b interprets the index value input from the conversion section 170b and outputs data representing the corresponding event (step S235). Next, the swapping section 174b swaps the entry corresponding to the appearing index value in the layer specific code number table 164b (step S240).

Processes in steps S245 to S275 are processes when a common code number table is referred to.

First, the conversion section 170a converts a codeword of the base layer into a code number by referring to the VLC table 166 (step S245). Next, the conversion section 170a converts the code number into an index value by referring to the common code number table 164 (step S250). Next, the index value interpretation section 172a interprets the index value input from the conversion section 170a and outputs data representing the corresponding event (step S255).

Also, the conversion section 170b converts a codeword of an enhancement layer into a code number by referring to the VLC table 166 (step S260). Next, the conversion section 170b converts the code number into an index value by referring to the common code number table 164 (step S265). Next, the index value interpretation section 172b interprets the index value input from the conversion section 170b and outputs data representing the corresponding event (step S270).

Then, the swapping section 174a swaps the entry corresponding to the index value appearing in the output from the conversion section 170a in the common code number table 164 (step S275).

If, after these processes for the syntax element to be processed are completed, any syntax element not yet processed remains in the prediction unit, the process returns to step S200 (step S280). On the other hand, no syntax element not yet processed remains, whether any remaining prediction unit is present is determined (S290). If, a still remaining prediction unit is present, the process returns to step S200 to repeat the above processes for the next prediction unit. If no remaining prediction unit is present, the flow chart in FIG. 14 terminates.

### 6. Application to Various Image Coding Schemes

Technology according to the present disclosure is applicable, as described above, not only to the scalable video coding, but also to, for example, the multi-view coding and interlaced coding. This section will describe an example in which technology according to the present disclosure is applied to the multi-view coding.

The multi-view coding is an image coding scheme to encode and decode so-called stereoscopic images. In the multi-view coding, two encoded streams corresponding to a right-eye view and a left-eye view of images displayed three-dimensionally are generated. One of these two views is selected as the base view and the other is called the non-base view. When multi-view image data is encoded, the data size of the encoded stream as a whole can be compressed by encoding pictures of the non-base view based on coding parameters of pictures of the base view.

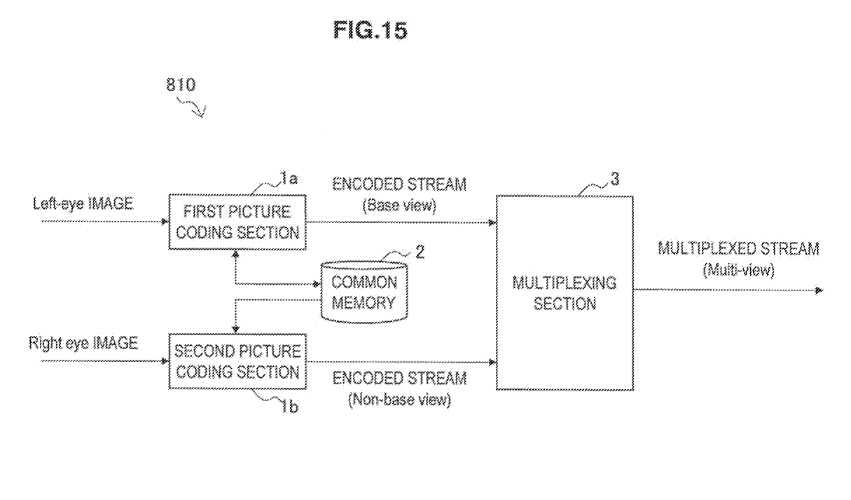

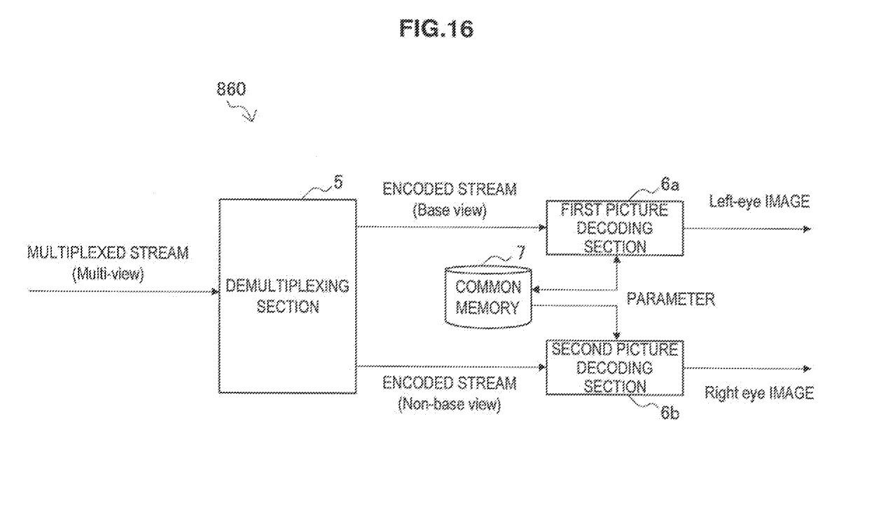

FIG. 15 is an explanatory view illustrating the application of the above image encoding processes according to an embodiment to the multi-view coding. Referring to FIG. 15, the configuration of a multi-view encoding device 810 as an example is shown. The multi-view encoding device 810 includes the first picture coding section 1a, the second picture coding section 1b, the common memory 2, and the multiplexing section 3. It is assumed here as an example that the left-eye view is handled as the base view.

The first picture coding section 1a encodes images of the left-eye view to generate an encoded stream of the base view. The second picture coding section 1b encodes images of the right-eye view to generate an encoded stream of the non-base view. The common memory 2 stores information used in common between views. The multiplexing section 3 multiplexes an encoded stream of the base view generated by the first picture coding section 1a and an encoded stream of the non-base view generated by the second picture coding section 1b to generate a multi-view multiplexed stream.

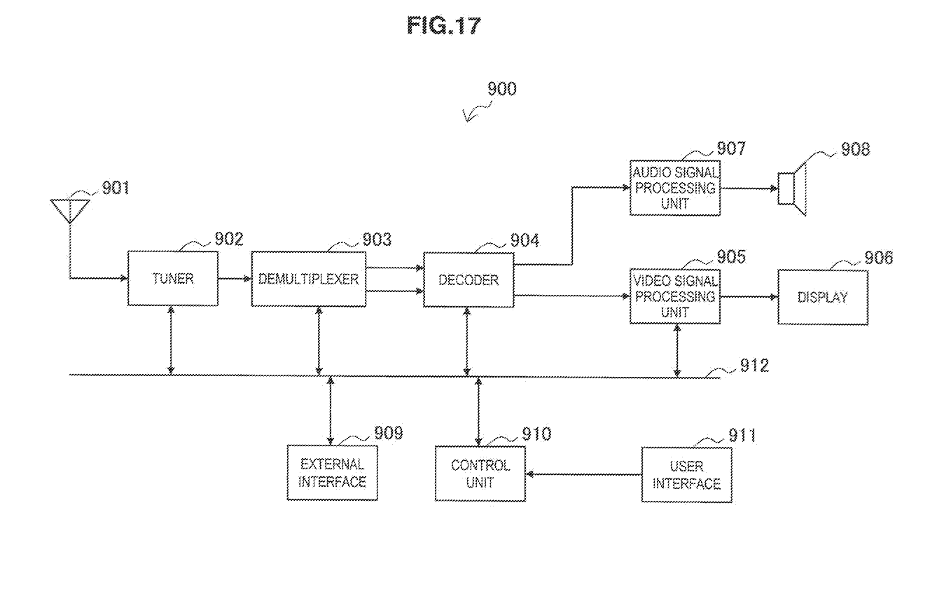

FIG. 16 is an explanatory view illustrating the application of the above image decoding processes according to an embodiment to the multi-view coding. Referring to FIG. 16, the configuration of a multi-view decoding device 860 as an example is shown. The multi-view decoding device 860 includes the demultiplexing section 5, the first picture decoding section 6a, the second picture decoding section 6b, and the common memory 7.

The demultiplexing section 5 demultiplexes a multi-view multiplexed stream into an encoded stream of the base view and an encoded stream of the non-base view. The first picture decoding section 6a decodes the encoded stream of the base view into images of the left-eye view. The second picture decoding section 6b decodes the encoded stream of the non-base view into images of the right-eye view. The common memory 7 stores information used in common between views.

When technology according to the present disclosure is applied to the interlaced coding, the first picture coding section 1a encodes one of two fields constituting one frame to generate a first encoded stream and the first picture decoding section 6a decodes the first encoded stream. The second picture coding section 1b encodes the other field to generate a second encoded stream and the second picture decoding section 6b decodes the second encoded stream.

### 7. Example Application

The image encoding device 10 and the image decoding device 60 according to the embodiment described above may be applied to various electronic appliances such as a transmitter and a receiver for satellite broadcasting, cable broadcasting such as cable TV, distribution on the Internet, distribution to terminals via cellular communication, and the like, a recording device that records images in a medium such as an optical disc, a magnetic disk or a flash memory, a reproduction device that reproduces images from such storage medium, and the like. Four example applications will be described below.

[7-1. First Application Example]

FIG. 17 is a diagram illustrating an example of a schematic configuration of a television device applying the aforementioned embodiment. A television device 900 includes an antenna 901, a tuner 902, a demultiplexer 903, a decoder 904, a video signal processing unit 905, a display 906, an audio signal processing unit 907, a speaker 908, an external interface 909, a control unit 910, a user interface 911, and a bus 912.

The tuner 902 extracts a signal of a desired channel from a broadcast signal received through the antenna 901 and demodulates the extracted signal. The tuner 902 then outputs an encoded bit stream obtained by the demodulation to the demultiplexer 903. That is, the tuner 902 has a role as transmission means receiving the encoded stream in which an image is encoded, in the television device 900.

The demultiplexer 903 isolates a video stream and an audio stream in a program to be viewed from the encoded bit stream and outputs each of the isolated streams to the decoder 904. The demultiplexer 903 also extracts auxiliary data such as an EPG (Electronic Program Guide) from the encoded bit stream and supplies the extracted data to the control unit 910. Here, the demultiplexer 903 may descramble the encoded bit stream when it is scrambled.

The decoder 904 decodes the video stream and the audio stream that are input from the demultiplexer 903. The decoder 904 then outputs video data generated by the decoding process to the video signal processing unit 905. Furthermore, the decoder 904 outputs audio data generated by the decoding process to the audio signal processing unit 907.

The video signal processing unit 905 reproduces the video data input from the decoder 904 and displays the video on the display 906. The video signal processing unit 905 may also display an application screen supplied through the network on the display 906. The video signal processing unit 905 may further perform an additional process such as noise reduction on the video data according to the setting. Furthermore, the video signal processing unit 905 may generate an image of a GUI (Graphical User Interface) such as a menu, a button, or a cursor and superpose the generated image onto the output image.

The display 906 is driven by a drive signal supplied from the video signal processing unit 905 and displays video or an image on a video screen of a display device (such as a liquid crystal display, a plasma display, or an OELD (Organic ElectroLuminescence Display)).

The audio signal processing unit 907 performs a reproducing process such as D/A conversion and amplification on the audio data input from the decoder 904 and outputs the audio from the speaker 908. The audio signal processing unit 907 may also perform an additional process such as noise reduction on the audio data.

The external interface 909 is an interface that connects the television device 900 with an external device or a network. For example, the decoder 904 may decode a video stream or an audio stream received through the external interface 909. This means that the external interface 909 also has a role as the transmission means receiving the encoded stream in which an image is encoded, in the television device 900.

The control unit 910 includes a processor such as a CPU and a memory such as a RAM and a ROM. The memory stores a program executed by the CPU, program data, EPG data, and data acquired through the network. The program stored in the memory is read by the CPU at the start-up of the television device 900 and executed, for example. By executing the program, the CPU controls the operation of the television device 900 in accordance with an operation signal that is input from the user interface 911, for example.

The user interface 911 is connected to the control unit 910. The user interface 911 includes a button and a switch for a user to operate the television device 900 as well as a reception part which receives a remote control signal, for example. The user interface 911 detects a user operation through these components, generates the operation signal, and outputs the generated operation signal to the control unit 910.

The bus 912 mutually connects the tuner 902, the demultiplexer 903, the decoder 904, the video signal processing unit 905, the audio signal processing unit 907, the external interface 909, and the control unit 910.

The decoder 904 in the television device 900 configured in the aforementioned manner has a function of the image decoding device 60 according to the aforementioned embodiment. Accordingly, for scalable video decoding of images by the television device 900, the code number table can be used more efficiently.

[7-2. Second Application Example]

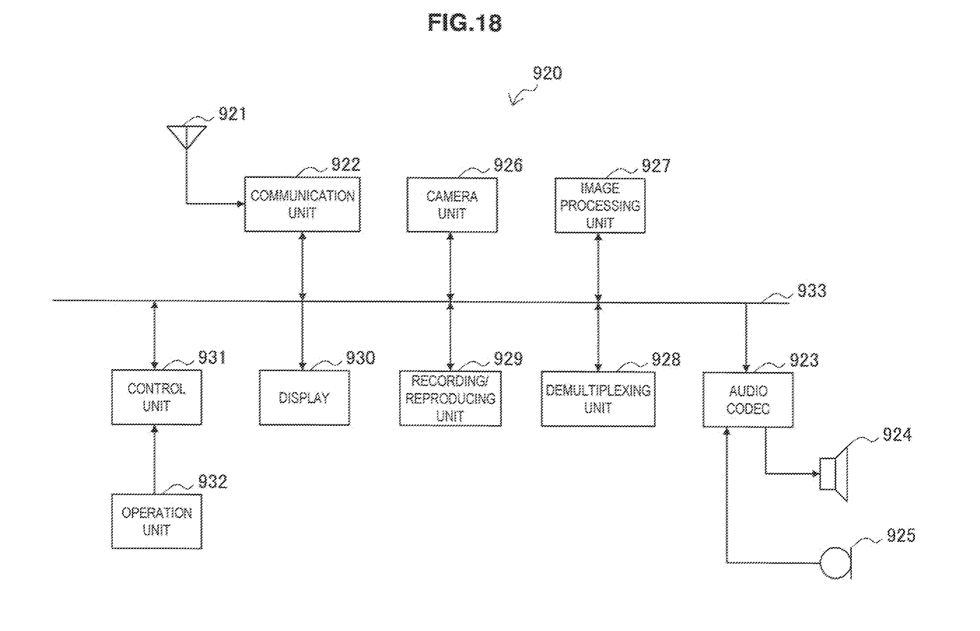

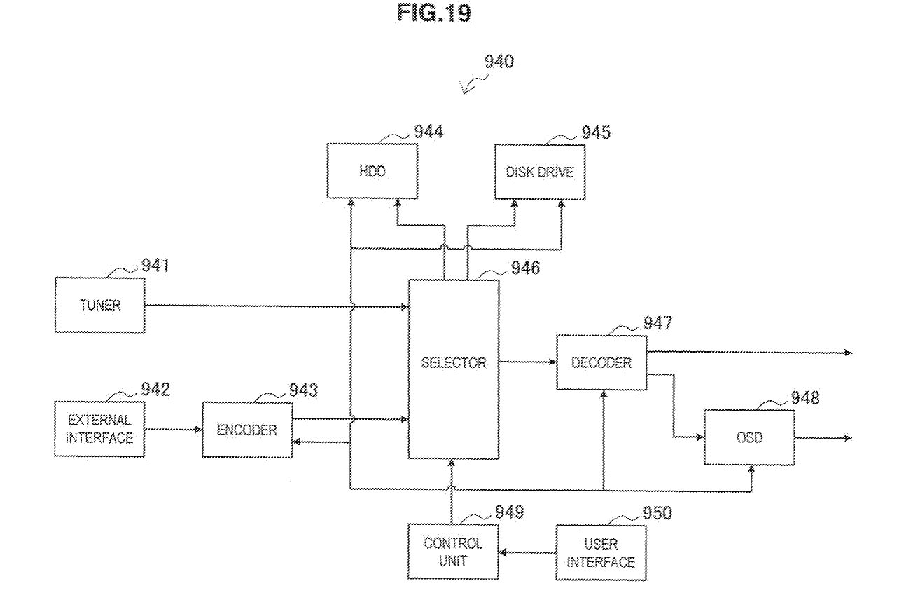

FIG. 18 is a diagram illustrating an example of a schematic configuration of a mobile telephone applying the aforementioned embodiment. A mobile telephone 920 includes an antenna 921, a communication unit 922, an audio codec 923, a speaker 924, a microphone 925, a camera unit 926, an image processing unit 927, a demultiplexing unit 928, a recording/reproducing unit 929, a display 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 mutually connects the communication unit 922, the audio codec 923, the camera unit 926, the image processing unit 927, the demultiplexing unit 928, the recording/reproducing unit 929, the display 930, and the control unit 931.

The mobile telephone 920 performs an operation such as transmitting/receiving an audio signal, transmitting/receiving an electronic mail or image data, imaging an image, or recording data in various operation modes including an audio call mode, a data communication mode, a photography mode, and a videophone mode.

In the audio call mode, an analog audio signal generated by the microphone 925 is supplied to the audio codec 923. The audio codec 923 then converts the analog audio signal into audio data, performs A/D conversion on the converted audio data, and compresses the data. The audio codec 923 thereafter outputs the compressed audio data to the communication unit 922. The communication unit 922 encodes and modulates the audio data to generate a transmission signal. The communication unit 922 then transmits the generated transmission signal to a base station (not shown) through the antenna 921. Furthermore, the communication unit 922 amplifies a radio signal received through the antenna 921, converts a frequency of the signal, and acquires a reception signal. The communication unit 922 thereafter demodulates and decodes the reception signal to generate the audio data and output the generated audio data to the audio codec 923. The audio codec 923 expands the audio data, performs D/A conversion on the data, and generates the analog audio signal. The audio codec 923 then outputs the audio by supplying the generated audio signal to the speaker 924.

In the data communication mode, for example, the control unit 931 generates character data configuring an electronic mail, in accordance with a user operation through the operation unit 932. The control unit 931 further displays a character on the display 930. Moreover, the control unit 931 generates electronic mail data in accordance with a transmission instruction from a user through the operation unit 932 and outputs the generated electronic mail data to the communication unit 922. The communication unit 922 encodes and modulates the electronic mail data to generate a transmission signal. Then, the communication unit 922 transmits the generated transmission signal to the base station (not shown) through the antenna 921. The communication unit 922 further amplifies a radio signal received through the antenna 921, converts a frequency of the signal, and acquires a reception signal. The communication unit 922 thereafter demodulates and decodes the reception signal, restores the electronic mail data, and outputs the restored electronic mail data to the control unit 931. The control unit 931 displays the content of the electronic mail on the display 930 as well as stores the electronic mail data in a storage medium of the recording/reproducing unit 929.

The recording/reproducing unit 929 includes an arbitrary storage medium that is readable and writable. For example, the storage medium may be a built-in storage medium such as a RAM or a flash memory, or may be an externally-mounted storage medium such as a hard disk, a magnetic disk, a magneto-optical disk, an optical disk, a USB (Unallocated Space Bitmap) memory, or a memory card.

In the photography mode, for example, the camera unit 926 images an object, generates image data, and outputs the generated image data to the image processing unit 927. The image processing unit 927 encodes the image data input from the camera unit 926 and stores an encoded stream in the storage medium of the storing/reproducing unit 929.

In the videophone mode, for example, the demultiplexing unit 928 multiplexes a video stream encoded by the image processing unit 927 and an audio stream input from the audio codec 923, and outputs the multiplexed stream to the communication unit 922. The communication unit 922 encodes and modulates the stream to generate a transmission signal. The communication unit 922 subsequently transmits the generated transmission signal to the base station (not shown) through the antenna 921. Moreover, the communication unit 922 amplifies a radio signal received through the antenna 921, converts a frequency of the signal, and acquires a reception signal. The transmission signal and the reception signal can include an encoded bit stream. Then, the communication unit 922 demodulates and decodes the reception signal to restore the stream, and outputs the restored stream to the demultiplexing unit 928. The demultiplexing unit 928 isolates the video stream and the audio stream from the input stream and outputs the video stream and the audio stream to the image processing unit 927 and the audio codec 923, respectively. The image processing unit 927 decodes the video stream to generate video data. The video data is then supplied to the display 930, which displays a series of images. The audio codec 923 expands and performs D/A conversion on the audio stream to generate an analog audio signal. The audio codec 923 then supplies the generated audio signal to the speaker 924 to output the audio.

The image processing unit 927 in the mobile telephone 920 configured in the aforementioned manner has a function of the image encoding device 10 and the image decoding device 60 according to the aforementioned embodiment. Accordingly, for scalable video coding and decoding of images by the mobile telephone 920, the code number table can be used more efficiently.

[7-3. Third Application Example]

FIG. 19 is a diagram illustrating an example of a schematic configuration of a recording/reproducing device applying the aforementioned embodiment. A recording/reproducing device 940 encodes audio data and video data of a broadcast program received and records the data into a recording medium, for example. The recording/reproducing device 940 may also encode audio data and video data acquired from another device and record the data into the recording medium, for example. In response to a user instruction, for example, the recording/reproducing device 940 reproduces the data recorded in the recording medium on a monitor and a speaker. The recording/reproducing device 940 at this time decodes the audio data and the video data.

The recording/reproducing device 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from a broadcast signal received through an antenna (not shown) and demodulates the extracted signal. The tuner 941 then outputs an encoded bit stream obtained by the demodulation to the selector 946. That is, the tuner 941 has a role as transmission means in the recording/reproducing device 940.

The external interface 942 is an interface which connects the recording/reproducing device 940 with an external device or a network. The external interface 942 may be, for example, an IEEE 1394 interface, a network interface, a USB interface, or a flash memory interface. The video data and the audio data received through the external interface 942 are input to the encoder 943, for example. That is, the external interface 942 has a role as transmission means in the recording/reproducing device 940.

The encoder 943 encodes the video data and the audio data when the video data and the audio data input from the external interface 942 are not encoded. The encoder 943 thereafter outputs an encoded bit stream to the selector 946.

The HDD 944 records, into an internal hard disk, the encoded bit stream in which content data such as video and audio is compressed, various programs, and other data. The HDD 944 reads these data from the hard disk when reproducing the video and the audio.

The disk drive 945 records and reads data into/from a recording medium which is mounted to the disk drive. The recording medium mounted to the disk drive 945 may be, for example, a DVD disk (such as DVD-Video, DVD-RAM, DVD-R, DVD-RW, DVD+R, or DVD+RW) or a Blu-ray (Registered Trademark) disk.

The selector 946 selects the encoded bit stream input from the tuner 941 or the encoder 943 when recording the video and audio, and outputs the selected encoded bit stream to the HDD 944 or the disk drive 945. When reproducing the video and audio, on the other hand, the selector 946 outputs the encoded bit stream input from the HDD 944 or the disk drive 945 to the decoder 947.

The decoder 947 decodes the encoded bit stream to generate the video data and the audio data. The decoder 904 then outputs the generated video data to the OSD 948 and the generated audio data to an external speaker.

The OSD 948 reproduces the video data input from the decoder 947 and displays the video. The OSD 948 may also superpose an image of a GUI such as a menu, a button, or a cursor onto the video displayed.

The control unit 949 includes a processor such as a CPU and a memory such as a RAM and a ROM. The memory stores a program executed by the CPU as well as program data. The program stored in the memory is read by the CPU at the start-up of the recording/reproducing device 940 and executed, for example. By executing the program, the CPU controls the operation of the recording/reproducing device 940 in accordance with an operation signal that is input from the user interface 950, for example.

The user interface 950 is connected to the control unit 949. The user interface 950 includes a button and a switch for a user to operate the recording/reproducing device 940 as well as a reception part which receives a remote control signal, for example. The user interface 950 detects a user operation through these components, generates the operation signal, and outputs the generated operation signal to the control unit 949.

The encoder 943 in the recording/reproducing device 940 configured in the aforementioned manner has a function of the image encoding device 10 according to the aforementioned embodiment. On the other hand, the decoder 947 has a function of the image decoding device 60 according to the aforementioned embodiment. Accordingly, for scalable video coding and decoding of images by the recording/reproducing device 940, the code number table can be used more efficiently.

[7-4. Fourth Application Example]

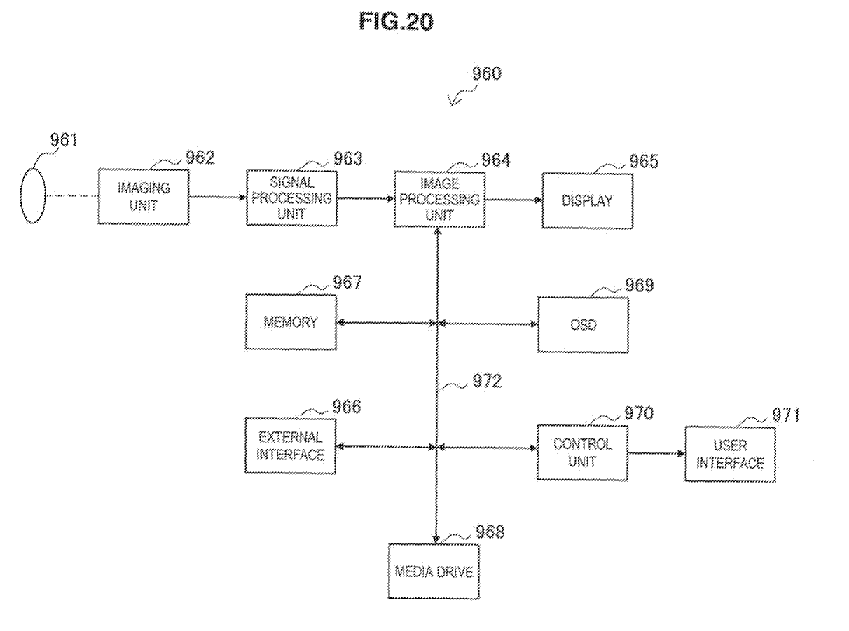

FIG. 20 shows an example of a schematic configuration of an image capturing device applying the aforementioned embodiment. An imaging device 960 images an object, generates an image, encodes image data, and records the data into a recording medium.

The imaging device 960 includes an optical block 961, an imaging unit 962, a signal processing unit 963, an image processing unit 964, a display 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display 965 is connected to the image processing unit 964. The user interface 971 is connected to the control unit 970. The bus 972 mutually connects the image processing unit 964, the external interface 966, the memory 967, the media drive 968, the OSD 969, and the control unit 970.

The optical block 961 includes a focus lens and a diaphragm mechanism. The optical block 961 forms an optical image of the object on an imaging surface of the imaging unit 962. The imaging unit 962 includes an image sensor such as a CCD (Charge Coupled Device) or a CMOS (Complementary Metal Oxide Semiconductor) and performs photoelectric conversion to convert the optical image formed on the imaging surface into an image signal as an electric signal. Subsequently, the imaging unit 962 outputs the image signal to the signal processing unit 963.

The signal processing unit 963 performs various camera signal processes such as a knee correction, a gamma correction and a color correction on the image signal input from the imaging unit 962. The signal processing unit 963 outputs the image data, on which the camera signal process has been performed, to the image processing unit 964.

The image processing unit 964 encodes the image data input from the signal processing unit 963 and generates the encoded data. The image processing unit 964 then outputs the generated encoded data to the external interface 966 or the media drive 968. The image processing unit 964 also decodes the encoded data input from the external interface 966 or the media drive 968 to generate image data. The image processing unit 964 then outputs the generated image data to the display 965. Moreover, the image processing unit 964 may output to the display 965 the image data input from the signal processing unit 963 to display the image. Furthermore, the image processing unit 964 may superpose display data acquired from the OSD 969 onto the image that is output on the display 965.

The OSD 969 generates an image of a GUI such as a menu, a button, or a cursor and outputs the generated image to the image processing unit 964.

The external interface 966 is configured as a USB input/output terminal, for example. The external interface 966 connects the imaging device 960 with a printer when printing an image, for example. Moreover, a drive is connected to the external interface 966 as needed. A removable medium such as a magnetic disk or an optical disk is mounted to the drive, for example, so that a program read from the removable medium can be installed to the imaging device 960. The external interface 966 may also be configured as a network interface that is connected to a network such as a LAN or the Internet. That is, the external interface 966 has a role as transmission means in the imaging device 960.

The recording medium mounted to the media drive 968 may be an arbitrary removable medium that is readable and writable such as a magnetic disk, a magneto-optical disk, an optical disk, or a semiconductor memory. Furthermore, the recording medium may be fixedly mounted to the media drive 968 so that a non-transportable storage unit such as a built-in hard disk drive or an SSD (Solid State Drive) is configured, for example.

The control unit 970 includes a processor such as a CPU and a memory such as a RAM and a ROM. The memory stores a program executed by the CPU as well as program data. The program stored in the memory is read by the CPU at the start-up of the imaging device 960 and then executed. By executing the program, the CPU controls the operation of the imaging device 960 in accordance with an operation signal that is input from the user interface 971, for example.

The user interface 971 is connected to the control unit 970. The user interface 971 includes a button and a switch for a user to operate the imaging device 960, for example. The user interface 971 detects a user operation through these components, generates the operation signal, and outputs the generated operation signal to the control unit 970.

The image processing unit 964 in the imaging device 960 configured in the aforementioned manner has a function of the image encoding device 10 and the image decoding device 60 according to the aforementioned embodiment. Accordingly, for scalable video coding and decoding of images by the imaging device 960, the code number table can be used more efficiently.

### 8. Summary

Heretofore, the image encoding device 10 and the image decoding device 60 according to an embodiment have been described using FIGS. 1 to 20. According to the present embodiment, when a plurality of encoded streams is generated in an image coding scheme in which a plurality of streams is encoded, a code number table referred to in common when the plurality of encoded streams is generated is introduced. Accordingly, memory resources needed to store code number tables can be saved.

Also according to the present embodiment, swapping occurs only once for each syntax element extending over a plurality of streams in the common code number table. The number of times of swapping of the code number table is thereby reduced and thus, the load of processor is reduced. Therefore, resources of the encoder and decoder can be used more efficiently.

Also according to the present embodiment, the conversion process and the swapping process using the common code number table for the plurality of encoded streams are performed in synchronization in prediction units. Accordingly, the common code number table can be referred to without holding an instance of the code number table for each encoded stream regarding a syntax element for intra prediction or inter prediction.

Also according to the present embodiment, the common code number table is introduced for syntax elements containing at least one of prediction mode information for intra prediction, prediction mode information for inter prediction, and reference image information. Tendencies of appearance of index values of these types of syntax elements are similar to some extent in cases in which spatial correlations and temporal correlations of images are similar between pictures. In this case, therefore, even if a common code number table is introduced, appropriate mapping (mapping of an index value with a higher appearance frequency to a shorter codeword) between the index value and the codeword can be maintained extending over a plurality of pictures.

Mainly described herein is the example where the various pieces of information such as the information related to intra prediction and the information related to inter prediction are multiplexed to the header of the encoded stream and transmitted from the encoding side to the decoding side. The method of transmitting these pieces of information however is not limited to such example. For example, these pieces of information may be transmitted or recorded as separate data associated with the encoded bit stream without being multiplexed to the encoded bit stream. Here, the term “association” means to allow the image included in the bit stream (may be a part of the image such as a slice or a block) and the information corresponding to the current image to establish a link when decoding. Namely, the 25 information may be transmitted on a different transmission path from the image (or the bit stream). The information may also be recorded in a different recording medium (or a different recording area in the same recording medium) from the image (or the bit stream). Furthermore, the information and the 30 image (or the bit stream) may be associated with each other by an arbitrary unit such as a plurality of frames, one frame, or a portion within a frame.

The preferred embodiments of the present disclosure have been described above with reference to the accompanying drawings, whilst the present disclosure is not limited to the above examples, of course. A person skilled in the art may find various alternations and modifications within the scope of the appended claims, and it should be understood that they will naturally come under the technical scope of the present disclosure.

Additionally, the present technology may also be configured as below.

(1)

An image processing apparatus including:

a code number table that holds a pair of a code number used in entropy coding and an index value of a syntax element;

a first conversion section that converts a first code number associated with a codeword contained in an encoded stream of a first picture of two or more pictures corresponding to a common scene into a first index value by referring to the code number table; and

a second conversion section that converts a second code number associated with a codeword contained in an encoded stream of a second picture of the two or more pictures into a second index value by referring to the code number table.

(2)

The image processing apparatus according to (1), further including: a swapping section that swaps entries of the code number table in accordance with an appearing index value.

(3)

The image processing apparatus according to (2), wherein a conversion process by the first conversion section, a conversion process by the second conversion section, and a swapping process by the swapping section are performed in synchronization in prediction units.

(4)

The image processing apparatus according to (3), wherein the swapping process by the swapping section is performed once after the conversion process by the first conversion section and the conversion process by the second conversion section.

(5)

The image processing apparatus according to (3) or (4), wherein the syntax element contains at least one of prediction mode information for intra prediction, prediction mode information for inter prediction, and reference image information.

(6)

The image processing apparatus according to any one of (1) to (5),

wherein the first picture corresponds to a first layer of an image to be scalable-video-coded, and

wherein the second picture corresponds to a second layer higher than the first layer.

(7)

The image processing apparatus according to (6), wherein the first layer and the second layer are different from each other in spatial resolution, signal to noise ratio, or bit depth.

(8)

The image processing apparatus according to any one of (1) to (5),

wherein the first picture corresponds to one of a right-eye view and a left-eye view of a three-dimensionally displayed image, and

wherein the second picture corresponds to the other of the right-eye view and the left-eye view of the image.

(9)

The image processing apparatus according to any one of (1) to (5),

wherein the first picture corresponds to a first field of an image to be interlaced-encoded, and

wherein the second picture corresponds to a second field of the image.

(10)

An image processing method including:

converting a first code number associated with a codeword contained in an encoded stream of a first picture of two or more pictures corresponding to a common scene into a first index value by referring to a code number table holding a pair of a code number used in entropy coding and an index value of a syntax element; and

converting a second code number associated with a codeword contained in an encoded stream of a second picture of the two or more pictures into a second index value by referring to the code number table.

(11)

An image processing apparatus including:

a code number table that holds a pair of a code number used in entropy coding and an index value of a syntax element;

a first conversion section that converts a first index value to be encoded for a first picture of two or more pictures corresponding to a common scene into a first code number by referring to the code number table; and

a second conversion section that converts a second index value to be encoded for a second picture of the two or more pictures into a second code number by referring to the code number table.

(12)

The image processing apparatus according to (11), further including: a swapping section that swaps entries of the code number table in accordance with an appearing index value.

(13)

The image processing apparatus according to (12), wherein a conversion process by the first conversion section, a conversion process by the second conversion section, and a swapping process by the swapping section are performed in synchronization in prediction units.

(14)

The image processing apparatus according to (13), wherein the swapping process by the swapping section is performed once after the conversion process by the first conversion section and the conversion process by the second conversion section.

(15)

The image processing apparatus according to (13) or (14), wherein the syntax element contains at least one of prediction mode information for intra prediction, prediction mode information for inter prediction, and reference image information.

(16)

The image processing apparatus according to any one of (11) to (15),

wherein the first picture corresponds to a first layer of an image to be scalable-video-coded, and

wherein the second picture corresponds to a second layer higher than the first layer.

(17)

The image processing apparatus according to (16), wherein the first layer and the second layer are different from each other in spatial resolution, signal to noise ratio, or bit depth.

(18)

The image processing apparatus according to any one of (11) to (15),

wherein the first picture corresponds to one of a right-eye view and a left-eye view of a three-dimensionally displayed image, and

wherein the second picture corresponds to the other of the right-eye view and the left-eye view of the image.

(19)

The image processing apparatus according to any one of (11) to (15),

wherein the first picture corresponds to a first field of an image to be interlaced-encoded, and

wherein the second picture corresponds to a second field of the image.

(20)

An image processing method including:

converting a first index value to be encoded for a first picture of two or more pictures corresponding to a common scene into a first code number by referring to a code number table holding a pair of a code number used in entropy coding and an index value of a syntax element; and

converting a second index value to be encoded for a second picture of the two or more pictures into a second code number by referring to the code number table.

### REFERENCE SIGNS LIST

10, 810 image encoding device (image processing apparatus)
104 code number table
112a first conversion section
112b second conversion section
114a swapping section
60, 860 image decoding device (image processing apparatus)
164 code number table
170a first conversion section
170b second conversion section
174a swapping section

1. An image processing apparatus comprising:
a code number table that holds a pair of a code number used in entropy coding and an index value of a syntax element;
a first conversion section that converts a first code number associated with a codeword contained in an encoded stream of a first picture of two or more pictures corresponding to a common scene into a first index value by referring to the code number table; and
a second conversion section that converts a second code number associated with a codeword contained in an encoded stream of a second picture of the two or more pictures into a second index value by referring to the code number table.

2. The image processing apparatus according to claim 1, further comprising: a swapping section that swaps entries of the code number table in accordance with an appearing index value.

3. The image processing apparatus according to claim 2, wherein a conversion process by the first conversion section, a conversion process by the second conversion section, and a swapping process by the swapping section are performed in synchronization in prediction units.

4. The image processing apparatus according to claim 3, wherein the swapping process by the swapping section is performed once after the conversion process by the first conversion section and the conversion process by the second conversion section.

5. The image processing apparatus according to claim 3, wherein the syntax element contains at least one of prediction mode information for intra prediction, prediction mode information for inter prediction, and reference image information.

6. The image processing apparatus according to claim 1,
wherein the first picture corresponds to a first layer of an image to be scalable-video-coded, and
wherein the second picture corresponds to a second layer higher than the first layer.

7. The image processing apparatus according to claim 6, wherein the first layer and the second layer are different from each other in spatial resolution, signal to noise ratio, or bit depth.

8. The image processing apparatus according to claim 1,
wherein the first picture corresponds to one of a right-eye view and a left-eye view of a three-dimensionally displayed image, and
wherein the second picture corresponds to the other of the right-eye view and the left-eye view of the image.

9. The image processing apparatus according to claim 1,
wherein the first picture corresponds to a first field of an image to be interlaced-encoded, and
wherein the second picture corresponds to a second field of the image.

10. An image processing method comprising:
converting a first code number associated with a codeword contained in an encoded stream of a first picture of two or more pictures corresponding to a common scene into a first index value by referring to a code number table holding a pair of a code number used in entropy coding and an index value of a syntax element; and
converting a second code number associated with a codeword contained in an encoded stream of a second picture of the two or more pictures into a second index value by referring to the code number table.

11. An image processing apparatus comprising:
a code number table that holds a pair of a code number used in entropy coding and an index value of a syntax element;
a first conversion section that converts a first index value to be encoded for a first picture of two or more pictures corresponding to a common scene into a first code number by referring to the code number table; and
a second conversion section that converts a second index value to be encoded for a second picture of the two or more pictures into a second code number by referring to the code number table.

12. The image processing apparatus according to claim 11, further comprising: a swapping section that swaps entries of the code number table in accordance with an appearing index value.

13. The image processing apparatus according to claim 12, wherein a conversion process by the first conversion section, a conversion process by the second conversion section, and a swapping process by the swapping section are performed in synchronization in prediction units.

14. The image processing apparatus according to claim 13, wherein the swapping process by the swapping section is performed once after the conversion process by the first conversion section and the conversion process by the second conversion section.

15. The image processing apparatus according to claim 13, wherein the syntax element contains at least one of prediction mode information for intra prediction, prediction mode information for inter prediction, and reference image information.

16. The image processing apparatus according to claim 11,
wherein the first picture corresponds to a first layer of an image to be scalable-video-coded, and
wherein the second picture corresponds to a second layer higher than the first layer.

17. The image processing apparatus according to claim 16, wherein the first layer and the second layer are different from each other in spatial resolution, signal to noise ratio, or bit depth.

18. The image processing apparatus according to claim 11,
wherein the first picture corresponds to one of a right-eye view and a left-eye view of a three-dimensionally displayed image, and
wherein the second picture corresponds to the other of the right-eye view and the left-eye view of the image.

19. The image processing apparatus according to claim 11,
wherein the first picture corresponds to a first field of an image to be interlaced-encoded, and
wherein the second picture corresponds to a second field of the image.

20. An image processing method comprising:
converting a first index value to be encoded for a first picture of two or more pictures corresponding to a common scene into a first code number by referring to a code number table holding a pair of a code number used in entropy coding and an index value of a syntax element; and
converting a second index value to be encoded for a second picture of the two or more pictures into a second code number by referring to the code number table.
